(19) United States
(12) Patent Application Publication
(10) Pub. No.: US 2024/0275829 A1
(43) Pub. Date: Aug. 15, 2024

(54) METHODS FOR UPGRADING A FIRST DATA SESSION FOR A FIRST MEDIA TYPE TO HANDLE A SECOND MEDIA TYPE, NETWORK NODES AND A COMMUNICATION DEVICE IMPLEMENTING THE METHODS IN A COMMUNICATIONS NETWORK

(71) Applicant: Telefonaktiebolaget LM Ericsson (publ), Stockholm (SE)

(72) Inventor: George Foti, Dollard des Ormeaux (CA)

(21) Appl. No.: 18/569,297

(22) PCT Filed: Jul. 27, 2021
(86) PCT No.: PCT/SE2021/050753

§ 371 Date: Dec. 12, 2023

(51) Int. Cl. H04L 65/1083

(52) U.S. Cl. CPC H04L 65/1086

(57) ABSTRACT

The method comprises receiving, from an application node associated with a communications network, a first identifier of a first network slice of the communications network. The first data session is established by a communications device through the first network slice; receiving a request, from the first communications device to upgrade the first data session to handle a second media type, wherein the request comprises session description information corresponding to an upgraded data session handling the second media type; and in response to the received request, and based on the first identifier of the first network slice and the session description information, sending an indication to the communications device that a second data session on a second network slice identified by a second identifier is required for the upgrade to handle the second media type to take place.

### TECHNICAL FIELD

The embodiments herein relate to methods for upgrading a first data session for a first media type to handle a second media type and network nodes and a communications device implementing the methods in a communications network. A corresponding computer program and computer program carrier are also disclosed.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to evolve the specifications of the Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn are connected to a network node 106. The access nodes 103-104 are part of a radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 corresponds typically to Evolved NodeBs (eNBs) and the network node 106 corresponds typically to either a Mobility Management Entity (MME) and/or a Serving Gateway (SGW).

The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

FIG. 2 illustrates a 5G reference architecture as defined by 3GPP.

For wireless communications systems pursuant to the 3GPP 5G System, 5GS (also referred to as New Radio, NR, or 5G) standard specifications, such as specified in 3GPP TS 38.300 and related specifications, on the other hand, the access nodes 103-104 of FIG. 1 correspond typically to a 5G NodeB (gNB) of a 5G Access Network (AN) 203 and the network node 106 corresponds typically to either an Access and Mobility Management Function (AMF) 206a and/or a User Plane Function (UPF) 206b. The 5G AN 203 may be a Radio Access Network (RAN) corresponding to the radio access network 10 of FIG. 1. In the 5G case the RAN is called NG-RAN (Next Generation Radio Access Network). The AMF 206a and UPF 206b are both part of the 5G Core Network (5GC). The gNBs may be inter-connected via an Xn interface, and connected to 5GC via the NG interface, more specifically via NG-C to the AMF and NG-U to the UPF. In FIG. 2 the NG-U interface is referred to as N3, while the NG-C interface is referred to as N2 in line with 3gpp terminology. An interface N1 is arranged between the UE 12 and the AMF 206a.

The AN 203 may further comprise an Access Gateway (AGW) (not shown in FIG. 2) which acts essentially as the Mobile IP client on behalf of the UE 12.

To support fast mobility between NR and LTE and avoid change of core network, LTE eNBs can also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

FIG. 2 further comprises an Application Function (AF) 220 that interacts with the 3GPP Core Network in order to provide services, for example to support interactions between the 5GC and an Internet Protocol (IP) Multimedia Subsystem or IP Multimedia Core Network Subsystem (IMS). Thus, the AF 220 may support IP-based multimedia services for the UE 12.

The IMS is a standardized architectural framework for delivering IP-based multimedia services. Historically, mobile phones have provided voice call services over a circuit-switched-style network, rather than strictly over an IP packet-switched network. However, now alternative methods of delivering voice, e.g., Voice over IP (VoIP), or other multimedia services have become available. VoIP over a 5G network may also be referred to as Vo5G or Voice over NR (VoNR).

A Proxy Call Session Control Function (P-CSCF) in the role of the AF 220 may interact with the Policy and Charging Architecture of the 5GC, for example with a Policy and Charging Function (PCF) 206d. The P-CSCF may be a first contact point within the IP Multimedia Core Network (IM CN) subsystem and it may ensure that relevant Session Initiation Protocol (SIP) messages contain the correct or up to date information about a user location information of the UE 12 provided by the access network 203 currently used by the UE 12.

The 5G System architecture supports an N5 interface between the PCF 206d and the P-CSCF and also supports an Rx interface between the PCF 206d and the P-CSCF, to enable IMS service. Rx support between the PCF 206d and the P-CSCF may be needed for backwards compatibility for early deployments using Diameter between the IMS and the 5GC functions.

The PCF 206d supports a unified policy framework to govern the network behavior. Specifically, the PCF 206d may provide Policy and Charging Control (PCC) rules to a Session Management Function (SMF) 206c together with an authorized Quality of Service (QoS) to be enforced by the SMF 206c. Further, the PCF 206d may request access network information, including user location information, from the SMF 206c and reports the received access network information, including the user location information, to the P-CSCF.

The SMF 206c supports different functionalities. Specifically, the SMF 206c may receive PCC rules from the PCF 206d over an N7 interface, enforce the authorized QoS and report the access network information to the PCF 206d as mentioned above. Further, the SMF 206c may have an N4 interface to the UPF 206b.

The IMS may further comprise a multimedia application server, such as a Multimedia Telephony Application Server (MTAS).

The IMS may further comprise other types of CSCFs, e.g., a Serving CSCF (S-CSCF) and an Interrogating CSCF (I-CSCF).

FIG. 3 illustrates two 5G reference architectures, an originating 5G network 200a and a terminating 5G network 200b involved in an IMS session, such as a VoIP session. An originating UE 12a in the originating 5G network calls a terminating UE 12b in the terminating 5G network 200b. The originating network 200a comprises an originating AN 203a, an originating CN 206a and an originating IMS 210a. The terminating network 200b comprises a terminating AN 203b, a terminating CN 206b and a terminating IMS 210b.

Virtual Reality (VR) is gaining more appeal among users due to its power of illustration among other things. Today, IMS is only setup for voice channels with limited bandwidth. The access network is also be restricted accordingly.

Thus, if a user wants to add VR to an ongoing voice call this will be problematic due to the limited bandwidth of the voice channel.

### SUMMARY

An object of embodiments herein may be to obviate some of the problems related to handling multiple media types during a communications session, or at least reduce the impact of them. For example, a specific object of embodiments herein may be to enable an upgrade of a data session, such as a Protocol Data Unit (PDU) session for IMS, for a first media type, such as voice, to handle a second media type, such as VR.

In embodiments herein the UEs are informed of what needs to be done in order to successfully either establish a new data session for the second media type, such as a VR IMS session, or upgrade the ongoing data session for the first media type, such as a normal IMS voice session, to handle the second media type as an add on mid-ongoing session.

According to a first aspect, the object is achieved by method for upgrading a first data session for a first media type to handle a second media type. The data session may be a multimedia session or be associated with a multimedia session, for example an IMS session. Thus in embodiments herein the data session may also be referred to as a service session. Thus, embodiments herein also describe methods for upgrading a first service session, such as a first IMS session, for a first media type to handle a second media type. For example, the first service session may be replaced by a second upgraded service session, such as a second IMS session, which handles the second media type. Each service session may be established over a respective PDU session.

The method comprises transmitting, by an application node associated with a communications network, to a policy controlling node of the communications network, a request for a first identifier of a first network slice of the communications network. The first network slice is used to set up the first data session to a communications device. Specifically, the data session may be set up between a first communications device, e.g., on an originating side of the data session, and a second communications device, e.g., on a terminating side of the data session.

The method further comprises receiving, by the application node, the first identifier of the first network slice from the policy controlling node in response to the transmitted request for the first identifier.

The method further comprises forwarding, by the application node, the first identifier of the first network slice to a multimedia application server.

The method further comprises receiving, by the multimedia application server, a request from the first communications device to upgrade the first data session to handle a second media type, wherein the request to handle the second media type comprises session description information corresponding to an upgraded data session handling the second media type.

The method further comprises sending, by the multimedia application server, in response to the received request, and based on the first identifier of the first network slice and the session description information, an indication to the communications device that a second data session on a second network slice identified by a second identifier is required for the upgrade to handle the second media type to take place. The indication may be sent to the first or the second communications device.

According to a second aspect, the object is achieved by a method, performed by a multimedia application server, for upgrading a first data session for a first media type to handle a second media type. The data session may be a multimedia session, for example an IMS session.

The method comprises receiving, from an application node associated with a communications network, a first identifier of a first network slice of the communications network. The first data session is established by a communications device through the first network slice. Specifically, the data session may be set up between a first communications device, e.g., on an originating side of the data session, and a second communications device, e.g., on a terminating side of the data session.

The method further comprises receiving a request, from the first communications device to upgrade the first data session to handle a second media type, wherein the request comprises session description information corresponding to an upgraded data session handling the second media type. The request may be received from the first communications device or the second communications device.

The method further comprises sending, in response to the received request, and based on the first identifier of the first network slice and the session description information, an indication to the communications device that a second data session on a second network slice identified by a second identifier is required for the upgrade to handle the second media type to take place. The indication may be sent to the first or the second communications device.

According to a third aspect, the object is achieved by a multimedia application server. The multimedia application server is configured to perform the method according to the second aspect.

According to a fourth aspect, the object is achieved by a method, performed by a communications device, for upgrading a first data session of a first media type to handle a second media type, the method comprising:
establishing a first data session between a first communications device and a second communications device. The communications device is one of the first or the second communications device. The first data session is established by the communications device on a first network slice of a communications network serving the communications device. The first network slice is identified by a first identifier; and
receiving, from a multimedia application server, associated with the communications network and controlling the first data session, an indication that a second data session on a second network slice identified by a second identifier is required for upgrading the first data session to handle the second media type.

According to a fifth aspect, the object is achieved by a communications device. The communications device is configured to perform the method according to the fourth aspect.

According to a sixth aspect, the object is achieved by a method, performed by an application node associated with a communications network, for assisting in upgrading a first data session for a first media type to handle a second media type. The method comprising:
transmitting, to a policy controlling node of the communications network, a request for a first identifier of a first network slice of the communications network. The first network slice is used to set up the first data session to a communications device;
receiving, from the policy controlling node, the first identifier of the first network slice in response to the transmitted request for the first identifier; and
forwarding the first identifier of the first network slice to a multimedia application server, such that the multimedia application server is able to determine whether or not the first data session is able to handle the second media type based on the first identifier of the first network slice and session description information corresponding to an upgraded data session handling the second media type.

According to a seventh aspect, the object is achieved by an application node. The application node is configured to perform the method according to the sixth aspect.

According to an eighth aspect, the object is achieved by a method, performed by a policy controlling node of a communications network. The method comprises:

Receiving, from an application node associated with the communications network, a request for a first identifier of a first network slice of the communications network. The first network slice is used for a first data session between a first communications device and a second communications device; and
sending the first identifier of the first network slice to the application node in response to the received request.

According to a ninth aspect, the object is achieved by a policy controlling node. The policy controlling node is configured to perform the method according to the sixth aspect.

According to a further aspect, the object is achieved by a computer program comprising instructions, which when executed by a processor, causes the processor to perform actions according to any of the aspects above.

According to a yet further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

Since the multimedia application server sends the indication to the communications device that the second data session on the second network slice is required for the upgrade in response to the request for the upgrade, and based on the first identifier of the first network slice and the session description information, the upgrade is enabled.

A further advantage of embodiments herein is that they enable upgrading the data session to handle second media types requiring higher bandwidth than the first media type. For example, the first media type may be voice, while the second media type may be used for providing video conferencing with multiple users or virtual reality.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 illustrates a simplified wireless communication system,

FIG. 2 illustrates a 5G reference architecture as defined by 3GPP,

FIG. 3 illustrates two 5G reference architectures as defined by 3GPP, corresponding to an originating and a terminating side of a data session,

FIG. 4 illustrates a procedure for handling IMS in 3gpp,

FIG. 5a illustrates a first communications network according to embodiments herein,

FIG. 5b illustrates a second communications network according to embodiments herein,

FIG. 6a illustrates a concept of network slices,

FIG. 6b also illustrates a concept of network slices,

FIG. 6c schematically illustrates how network slices handles different services according to embodiments herein,

FIG. 7a illustrates details of a method for upgrading an IMS session according to embodiments herein,

FIG. 7b illustrates further details of a method for upgrading an IMS session according to embodiments herein,

FIG. 7c illustrates yet further details of a method for upgrading an IMS session according to embodiments herein,

FIG. 7d illustrates yet further details of a method for upgrading an IMS session according to embodiments herein,

FIG. 8 is a flow chart and illustrates a method for upgrading an IMS session according to embodiments herein,

FIG. 9 is a flow chart and illustrates a method for upgrading an IMS session according to embodiments herein,

FIG. 10 is a flow chart and illustrates a method for upgrading an IMS session according to embodiments herein,

FIG. 11 is a flow chart and illustrates a method for upgrading an IMS session according to embodiments herein,

FIG. 12 illustrates a multimedia application server for upgrading an IMS session according to embodiments herein,

FIG. 13 illustrates a communications device for upgrading an IMS session according to embodiments herein,

FIG. 14 illustrates an application node for upgrading an IMS session according to embodiments herein.

FIG. 15 illustrates a policy controlling node for upgrading an IMS session according to embodiments herein.

FIG. 16 schematically illustrates a telecommunication network connected via an intermediate network to a host computer.

FIG. 17 is a generalized block diagram of a host computer communicating via a base station with a user equipment over a partially wireless connection.

FIGS. 18 to 21 are flowcharts illustrating methods implemented in a communication system including a host computer, a base station and a user equipment.

### DETAILED DESCRIPTION

As mentioned above, an object of embodiments herein may be to obviate some of the problems related to upgrading an IMS session in connection with a service provided by a communications network. The service may for example be a voice service.

For example, if a user wants to add VR to an ongoing voice call this will be problematic due to the limited bandwidth of the voice channel. Thus, an object of embodiments herein may be to obviate some of the problems related to handling multiple media types requiring substantially different network performance and resources during a communications session.

In embodiments herein communications devices, such as UEs, are informed of what needs to be done in order to successfully either establish a new data session for the second media type, such as a VR IMS session, or upgrade the ongoing data session for the first media type, such as a normal IMS voice session, to handle the second media type as an add on mid-ongoing session.

In embodiments herein the IMS domain acquires information about the network slice, e.g., as identified by the Single Network Slice Selection Assistance Information (S-NSSAI), used for a PDU IMS session, that is a PDU session for IMS services. This enables the IMS domain to decide whether an IMS session may be upgraded to handle VR or not. The IMS domain is configured with the S-NSSAIs that identify network slices that are able to handle VR. The IMS domain is therefore able to check whether or not the currently used S-NSSAI used is adequate for VR as well.

With the above in mind, embodiments herein propose that the MTAS acquires the S-NSSAI used for the PDU session for IMS, e.g., during IMS session setup. This enables the MTAS to decide on the appropriate action if a UE for example initiates a regular IMS session and wants to upgrade it mid-session to handle VR or initiates a VR session from the get-go, that is from the IMS session setup. Embodiments herein will be exemplified with the mid-session upgrade.

The MTAS instructs the originating UE and the terminating UE if a new PDU IMS session with a new appropriate S-NSSAI is required or not.

If one of the UEs cannot establish a new PDU session for IMS because it does not have the correct subscription for the required S-NSSAI, it may reject the session or the request to upgrade the ongoing IMS session.

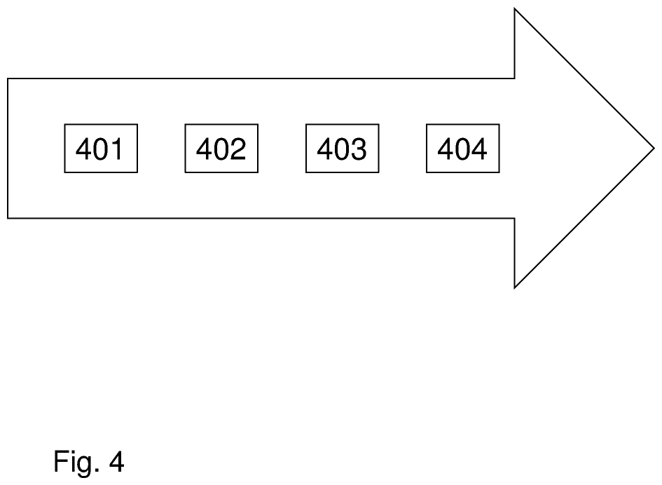

Embodiments herein relate to IMS and therefore a brief overview of a procedure for establishing an IMS session will first be given with reference to FIG. 4. In action 401 a UE attaches to a communications network, such as a 5G network. For example, a UE may make an NR Attach to an NR access network. In action 402 a default PDU session is established with the communications network, e.g., with a core network. In action 403 a default IMS session is established with the communications network. The default IMS session may be associated with a network slice that have certain restrictions, such as a maximum bandwidth and other metrics associated with the network slice, e.g., to optimize network resources. In action 404 the UE makes a SIP/IMS registration in the IMS, that is with an application function of the communications network. After action 404 a dedicated IMS session to for example a second UE may be established over a dedicated PDU session. For the dedicated IMS session also a subscription of the UE may put certain other restrictions on the dedicated IMS session.

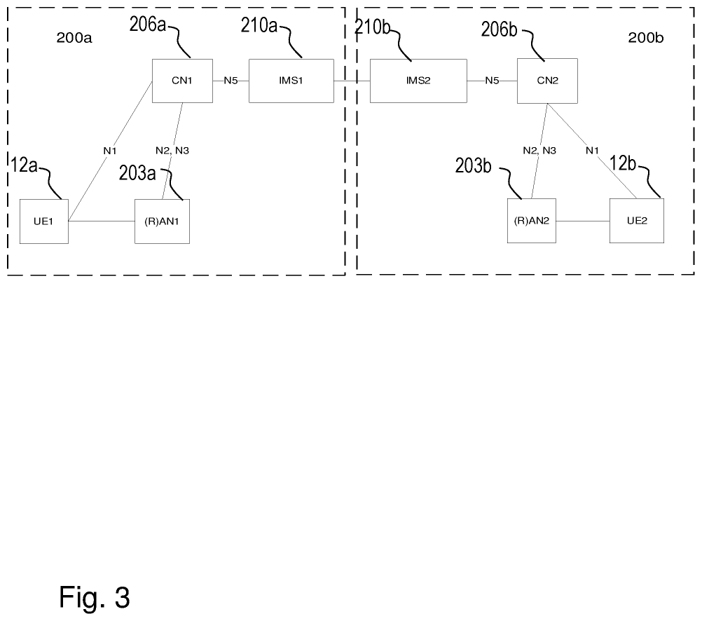

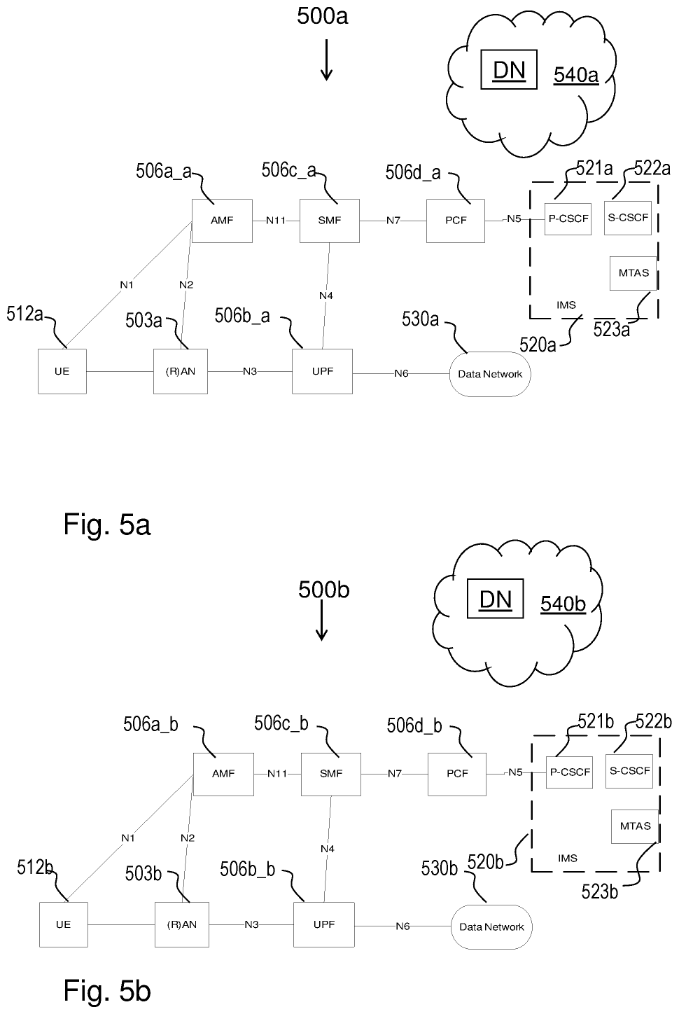

Embodiments herein relate to communications networks in general. FIG. 5a is a schematic overview depicting a communications network, such as a first communications network 500a wherein embodiments herein may be implemented. The first communications network 500a may correspond to the originating network 200a of FIG. 3. The first communications network 500a comprises one or more access networks, such as a first AN 503a and one or more CNs, such as a first CN. A 5G network architecture has been used in FIG. 5a to illustrate the first communications network 500a. In the following description embodiments will be described with reference to this 5G reference architecture. However, embodiments are also applicable to other network architectures, in particular to 4G network architectures.

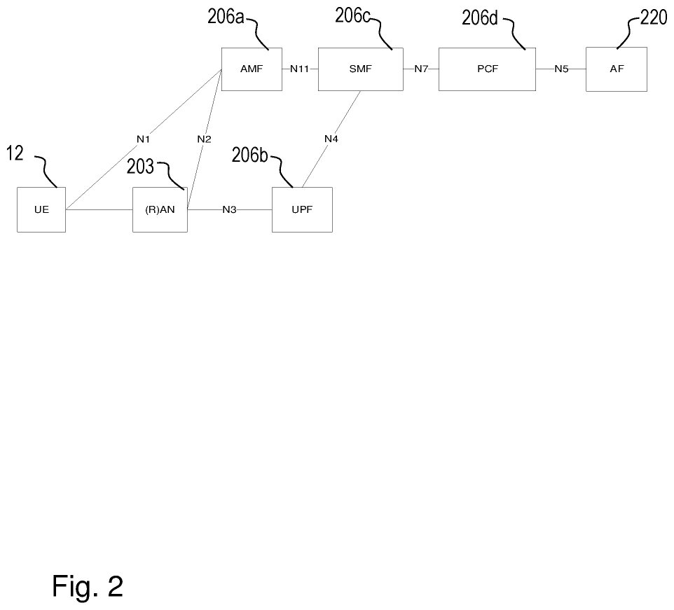

Each CN of the first communications network 500a comprises one or more CN nodes, such as a first session management node 506c_a implementing the SMF 206c and a first policy controlling node 506d a implementing the PCF 206d. The first policy controlling node 506d_a may besides handling policies for resource reservation also handle charging. The first CN may further comprise a first access and mobility management node 506a_a implementing the AMF 206a and a first user plane node 506b_a implementing the UPF 206b. The SMF 206c, the PCF 206d, the AMF 206a and the UPF 206b were all described above in relation to FIG. 2.

In a 4G-embodiment the first session management node 506c_a and the first access and mobility management node 506a_a may be implemented by a Mobility Management Entity (MME). The first user plane node 506b_a may be implemented by a Packet Data Network Gateway (PDN-GW) in 4G.

The CN nodes may be logical nodes for performing the above-mentioned CN functions which each may be implemented in one or more physical nodes or devices.

The first communications network 500a may be a wireless communications network, or a communications network supporting wireless and wireline convergence, such as 5G Wireless Wireline Convergence.

Then the first AN 503a may comprise one or more RANs. The wireless communications network may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context. However, embodiments are also applicable in further development of the existing wireless communications systems such as e.g. LTE.

Access nodes operate in the communications network 500 such as a radio access node. The radio access node provides radio coverage over a geographical area, a service area referred to as a cell, which may also be referred to as a beam or a beam group of a first radio access technology (RAT), such as 5G, LTE, Wi-Fi or similar. The radio access node may be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area depending e.g. on the radio access technology and terminology used. The respective radio access node may be referred to as a serving radio access node and communicates with a UE with Downlink (DL) transmissions to the UE and Uplink (UL) transmissions from the UE.

A number of communications devices operate in the communications network 500, such as a first communications device 512a. The first communications device 512a may correspond to the originating UE 12a of FIG. 3. The first communications device 512a may be a wireless communications device. Further, the first communications device 512a may be a mobile station, a non-access point (non-AP) STA, a STA, a user equipment (UE) and/or a wireless terminal, that communicate via one or more Access Networks (AN), e.g. RAN, e.g. via the radio access node to one or more CNs.

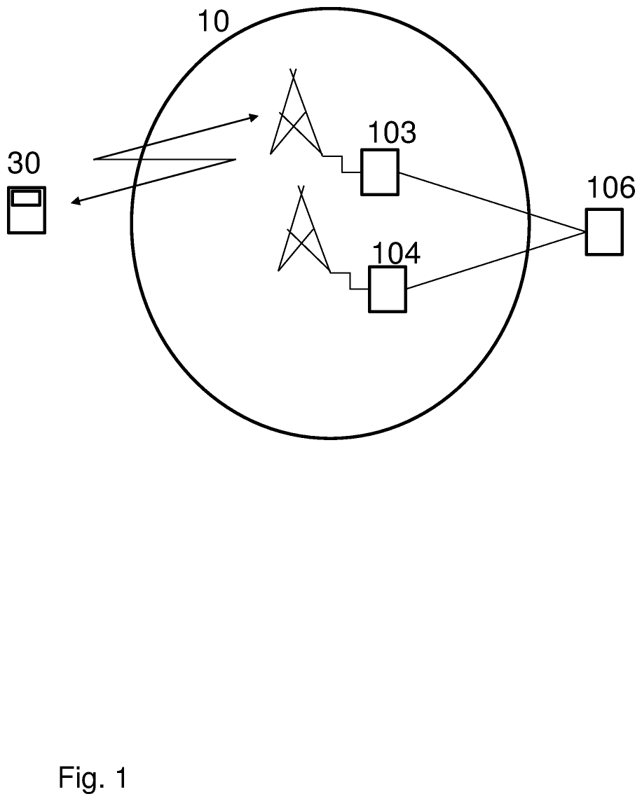

The first AN 503a may be a Radio Access Network (RAN) corresponding to the radio access network 10 of FIG. 1. In the 5G case the RAN is called NG-RAN (Next Generation Radio Access Network). The gNBs may be inter-connected via an Xn interface, and connected to 5GC via the NG interface, more specifically via NG-C to the AMF and NG-U to the UPF. The interfaces between the nodes of FIG. 5a correspond to the interfaces of FIG. 2. Specifically, FIG. 5a shows a first interface N1 between the communications device 512a and the first access and mobility management node 506a_a, a second interface N2 between the first AN 503a and the first access and mobility management node 506a_a, a third interface N3 between the first AN 503a and the first user plane node 506b_a, a fourth interface N4 between the first user plane node 506b_a and the session management node 506c_a, a fifth interface N5 between the first policy controlling node 506d_a and the application node 520a and a further interface N7 between the session management node 506c_a and the first policy controlling node 506d_a. The first access and mobility management node 506a_a may further be interfaced to the first session management node 506c_a with an interface referred to as N11.

FIG. 5b illustrates a second communications network 500b wherein embodiments herein may be implemented. The second communications network 500b may correspond to the terminating network 200b of FIG. 3. The second communications network 500b may comprise components corresponding to the components of the first communications network 500a. In particular, the second communications network 500b comprises one or more access networks, such as a second AN 503b and one or more CNs, such as a second CN. For example, the second communications network 500b may comprise a second session management node 506c_b implementing the SMF 206c and a second policy controlling node 506d_b implementing the PCF 206d. The second CN may further comprise a second access and mobility management node 506a_b implementing the AMF 206a and a second user plane node 506b_b implementing the UPF 206b.

The second communications network 500b may be a wireless communications network or a communications network supporting wireless and wireline convergence, such as 5G Wireless Wireline Convergence.

A number of communications devices operate in the second communications network 500b, such as a second communications device 512b. The second communications device 512b may correspond to the terminating UE 12b of FIG. 3. The second communications device 512b may be a wireless communications device. The same interfaces as defined for the first communications network 500a may also be defined for the second communications network 500b.

In some embodiments the second communications network 500b is the same communications network as the first communications network 500a.

FIGS. 5a and 5b further illustrate an application layer system, such as a first application layer system, also referred to herein as a first application network 520a, associated with or comprised in the first communications network 500a, and a second application layer system, also referred to herein as a second application network 520b, associated with the second communications network 500b. The respective application network 520a, 520b is connected to the respective CN of the respective communications network 500a, 500b. The application network may be an IMS. The application network 520a, 520b comprises one or more application functions, such as the P-CSCF and IMS core functions, such as Serving-Call Session Control Function (S-CSCF), Interrogating-Call Session Control Function I-CSCF, and IMS Application Servers. The first application network 520a comprises one or more application nodes, such as a first application node 521a and a first core application node 522a for providing a service for the first communications device 512a.

The second application network 520b comprises one or more application nodes, such as a second application node 521b and a second core application node 522b for providing a service for the second communications device 512b.

For example, the P-CSCF may be implemented by the first and the second application nodes 521a, 521b while an IMS core function, such as the S-CSCF, may be implemented by the first and second core application nodes 522a, 522b. In general, the one or more application nodes may be logical nodes for performing the above-mentioned application functions. Each application node may be implemented in one or more physical nodes or devices.

As mentioned above, the IMS further comprises a multimedia application server, such as a first multimedia application server 523a in the first application network 520a and a second multimedia application server 523b in the second application network 520b.

Generally, an application function interacts with the CN to provide specific services, such as voice, video, gaming, and VR, and may affect routing and/or policy decisions affecting quality of service. An example of an application function is IMS providing voice and video calling services. In embodiments herein the services may be real-time services providing real-time data, such as real-time media.

The service may be provided to the communications device 512a, 512b through the CN of the communications network 500a, 500b. For example, the service may be provided by a data session, such as a Protocol Data Unit (PDU) session. The data session provides end-to-end user plane connectivity between the communications device 512a, 512b and a specific Data Network 530a, 530b through the user plane node 506b_a, 506b_b. For example, for voice over IMS a PDU session for IMS voice may provide end-to-end user plane connectivity between the first communications device 512a and the second communications device 512b in the second communications network 500b.

A data session, such as a PDU Session, may support one or more QoS Flows. There may be a one-to-one mapping between QoS Flow and QoS profile. For example, for 5G the one-to-one mapping between QoS Flow and QoS profile means that all packets belonging to a specific QoS Flow may have the same 5Q1.

The session management node, such as the first session management node 506c_a, or the second session management node 506c_b may control the data session through the N4 interface.

It should be understood by the skilled in the art that “communications device” and “UE” are non-limiting terms which mean any terminal, wireless terminal, user equipment, Machine Type Communication (MTC) device, Device to Device (D2D) terminal, or node e.g. smart phone, laptop, mobile phone, sensor, relay, mobile tablets or even a small base station communicating within a cell.

Methods herein may in a first aspect be performed by a multimedia application server, such as the first multimedia application server 523a or the second multimedia application server 523b, and in a second aspect by a communications device, such as the first or the second communication device 512a, 512b, and in a third aspect by an application node, such as the first and the second application node 521 a, 521b, and in a fourth aspect by a policy controlling node, such as the first or the second policy controlling node 506d_a, 506d_b. As an alternative, a Distributed Node (DN) and functionality, e.g. comprised in a first cloud 540a as shown in FIG. 5a, or a second cloud 540b as shown in FIG. 5b, may be used for performing or partly performing the methods.

In the cloud implementation, the functions of anyone or all of the multimedia application server 523a, 523b, the communications device 512a, 512b, the application node 521a, 521b, and the policy controlling node 506d_a, 506d_b may be deployed in a virtualized environment. The signaling sequences between the nodes or functions does not change if some or all of them are deployed in the cloud.

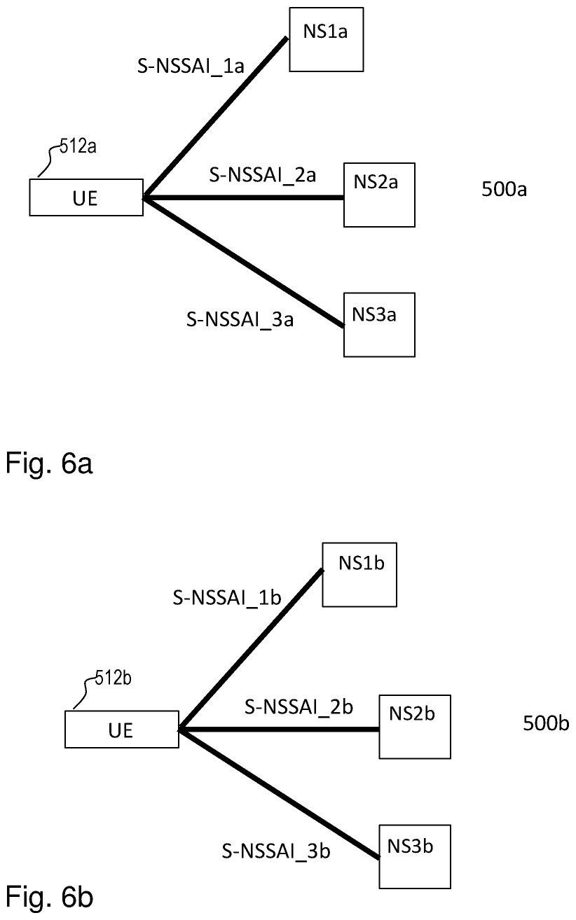

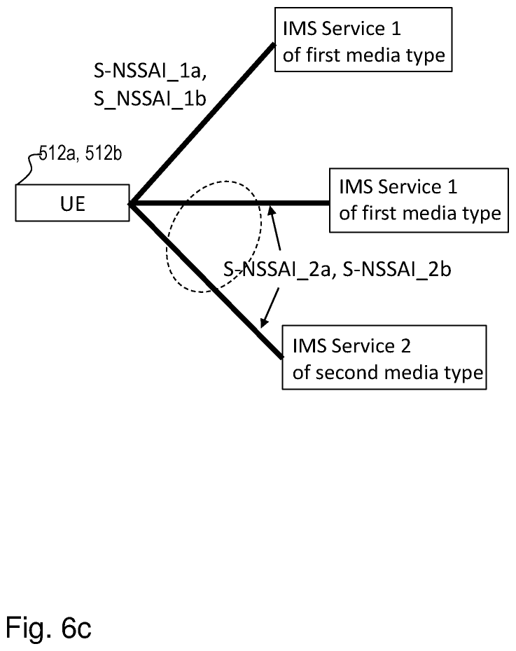

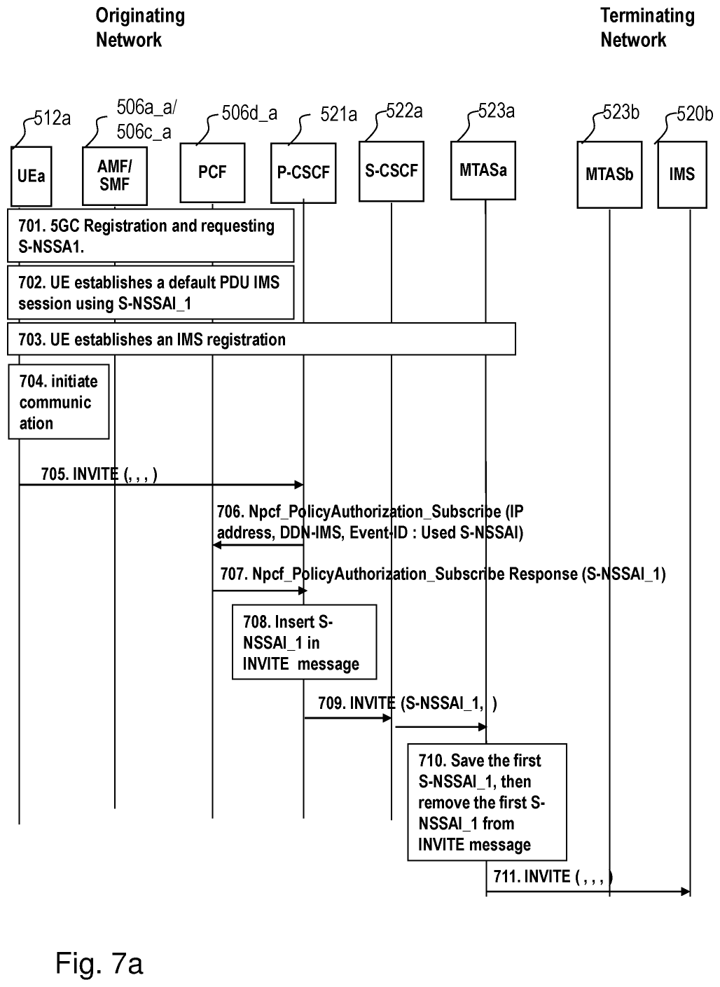

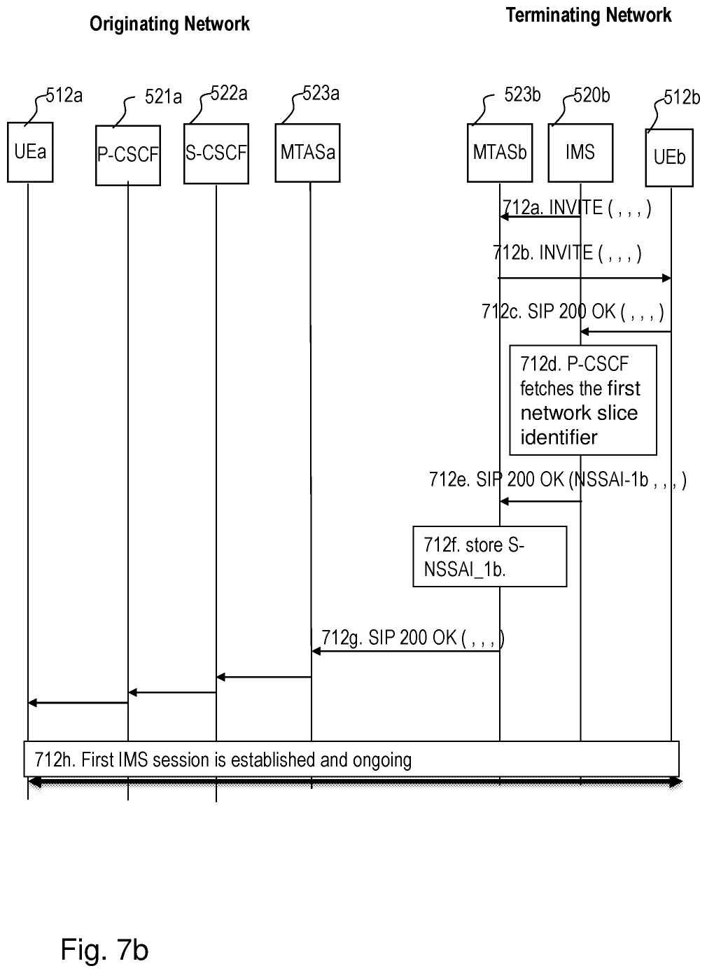

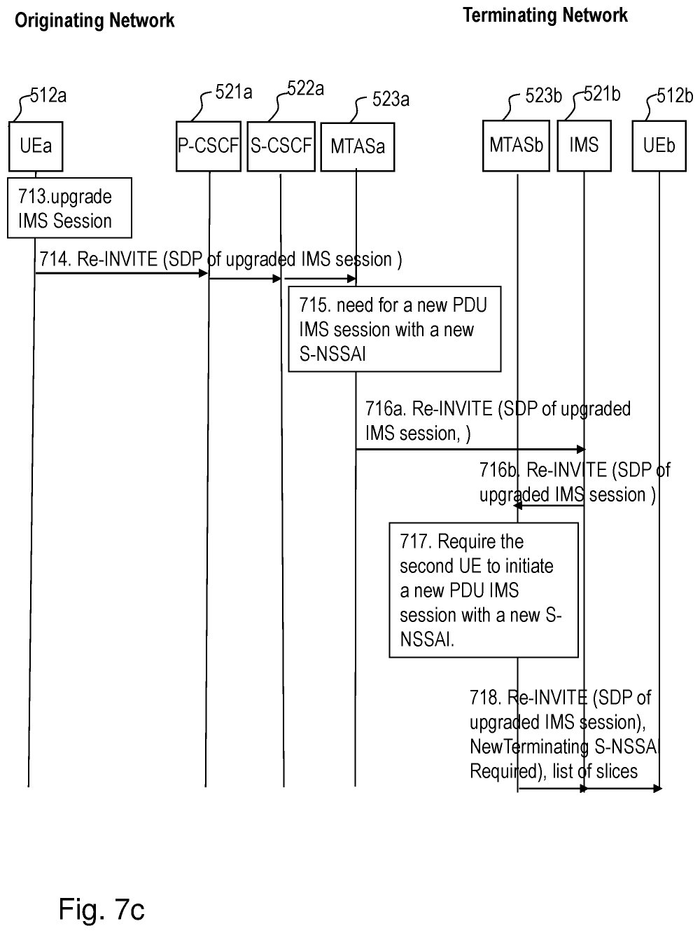

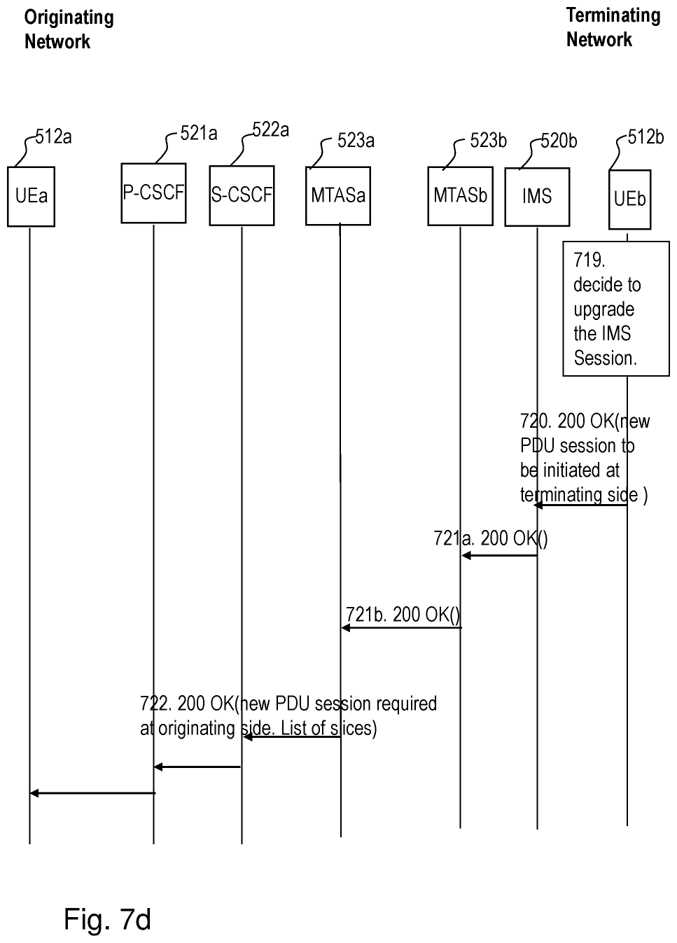

Exemplifying methods for upgrading a first data session for a first media type to handle a second media type according to embodiments herein will now be described with reference to FIGS. 6a, 6b and 6c and the combined signalling diagrams and flow charts of FIGS. 7a-7d describing interaction between the multimedia application server 523a, 523b, the communications device 512a, 512b, the application node 521 a, 521b, and the policy controlling node 506d_a, 506d_b.

The data session may also be referred to as a service session. Thus, embodiments herein describe methods for upgrading a first service session, such as a first IMS session, for a first media type to handle a second media type. For example, the first service session may be replaced by a second upgraded service session, such as a second IMS session, which handles the second media type. Each service session may be established over a respective PDU session.

The exemplifying methods will also be described with further reference to FIGS. 5a and 5b. The embodiments will be described based on a 5G architecture combined with an IMS. The first media type provided by the application network 520a, 520b will be exemplified with a voice service, such as VoIP and in particular Voice over NR (VoNR). The data session will be exemplified with a PDU IMS session, that is a PDU session for IMS services.

FIG. 6a illustrates the concept of dividing the communications network 500a, 500b into network slices. Each network slice may be identified by a corresponding network slice identifier, such as an S-NSSAI.

FIG. 6a illustrates the network slice concept on the first communications network 500a. A first network slice NS1 a of the first communications network 500a identified by a first identifier S-NSSAI_1a, a second network slice NS2a identified by a second identifier S-NSSAI_2a and a third network slice NS3a is identified by a third identifier S-NSSAI_3a.

FIG. 6b illustrates the network slice concept on the second communications network 500b. A first network slice NS1b of the second communications network 500b is identified by a first identifier S-NSSAI_1b, a second network slice NS2b is identified by a second identifier S-NSSAI_2 and a third network slice NS3b is identified by a third identifier S-NSSAI_3.

FIG. 6c illustrates how different network slices may provide different services to the communications device 512a, 512b. For example, the first network slice NS1a, NS1b may provide a first IMS service of a first media type, such as voice, while the second network slice NS2a, NS2b may provide the first IMS service of the first media type and a second IMS service of a second media type, such as video or VR.

The exemplifying methods disclosed in connection with FIGS. 7a-7d are described with the assumption that a regular first IMS session, such as a voice session, is first established, then one of the first and second communications devices 512a, 512b requests an upgrade for the IMS session to handle the second media type, such as VR.

It is further assumed that the first communications network 500a represents the originating side and the second communications network 500b represents the terminating side. The following may be a description of actions in a call flow. Actions 701 to 703 are valid for both the originating side and the terminating side. Thus, both the first communications device 512a and the second communications device 512b perform these actions. However, FIG. 7a only illustrates them for the first communications device 512a.

### Action 701

The communications devices 512a, 512b, such as the first communications device 512a and the second communications device 512b, may each register in 5GC, e.g., according to 3gpp TS 23.502 v. 17.1.0.

### Action 702

The communications device 512a, 512b may establish a default data session, such as a default PDU IMS session, i.e., a PDU session for IMS, e.g., in accordance with 3gpp TS 23.502 17.1.0.

### Action 703

The communications device 512a, 512b registers in IMS, e.g., according to 3gpp TS 23.228 17.1.0 and TS 24.229 17.3.1.

### Action 704

The communications device 512a, 512b initiates a dedicated service session over a dedicated data session, such as a dedicated PDU session for IMS, with another communications device 512a, 512b. For example, the first communications device 512a initiates a dedicated IMS session over a dedicated PDU session for IMS with the second communications device 512b based on end user activity.

### Action 705

The first communications device 512a initiates a dedicated service session over a dedicated PDU session for IMS towards the second communications device 512b by sending a session control message indicating a session initiation to the second communications device 512b. The session control message indicating the session initiation may also be referred to as a session initiation message. For example, the first communications device 512a initiates an IMS session towards the second communications device 512b by sending a SIP INVITE to the second communications device 512b according to 3gpp TS 24.229 v. 17.3.1.

### Action 706

The first application node 521 a may send an Npcf_PolicyAuthorisation_Subscribe to the first policy controlling node 506d_a to fetch the first identifier of the first network slice S-NSSAI_1a used for this IMS session. This may be done in response to the SIP INVITE message from the first communications device 512a.

### Action 707

The first identifier of the first network slice S-NSSAI_1a used is returned from the first policy controlling node 506d_a in the response in action 707.

### Action 708

The first application node 521 a inserts the first network slice identifier S-NSSAI_1 a used for the data session in the INVITE message to the first multimedia application server 523a.

### Action 709

The first application node 521 a forwards the first network slice identifier S-NSSAI_1a used for the first IMS session in the SIP INVITE message to the second application node 522a, such as an S-CSCF. The SIP INVITE message is transmitted to the first multimedia application server 523a.

### Action 710

The first multimedia application server 523a saves the S-NSSAI 1 used for the IMS session in the session state.

### Action 711

The first multimedia application server 512a may remove the S-NSSAI1 from the SIP INVITE message before forwarding the SIP INVITE message to a node in the second application network 520b, such as the terminating IMS network 520b.

In the terminating network 500b similar actions take place in the IMS nodes as in the originating network 500a. FIG. 7b illustrates these actions.

### Action 712a

Specifically, the second multimedia application server 523b at the terminating end may receive a SIP INVITE via the second application network 520b.

### Action 712b

The second multimedia application server 523b may then forward the SIP INVITE to the second communications device 512b on the terminating side.

### Action 712c

The UE sends a SIP 200 OK to the originating side.

### Action 712d

When a SIP 200 OK sent from the second communications device 512b arrives at the second application node 521b at the terminating end in the second application network 520b, it fetches the first network slice identifier S-NSSAI_1 b used by the second communications device 512b from the second policy controlling node 506d_b, e.g. by sending an Npcf_PolicyAuthorisation_Subscribe as described in action 706 above.

### Action 712e

The second application node 521b forwards the SIP 200 OK, and includes the first network slice identifier S-NSSAI_1b used by the second communications device 512b, to the second multimedia application server 523b.

### Action 712f

Then the second multimedia application server 523b stores the first network slice identifier S-NSSAI_1b of the second communications device 512b in the IMS session state associated with the first IMS session of the second communications device 512b.

### Action 712g

The second multimedia application server 523b strips the first network slice identifier S-NSSAI_1b from the SIP 200 OK before forwarding the SIP 200 OK onwards.

### Action 712h

The IMS session between the first communication device 512a and the second communication device 512b is then established. Both the first multimedia application server 523a and the second multimedia application server 523b have stored the first network slice identifier S-NSSAI_1a, S-NSSAI_1b used by the first communications device 512a and the second communications device 512b respectively for establishing the PDU session for IMS. That is, the first multimedia application server 523a have stored the first network slice identifier S-NSSAI_1a of the first communications network (originating side), while the second multimedia application server 523b have stored the first network slice identifier S-NSSAI_1 b of the second communications network (terminating side).

### Action 713

At some later point in the IMS session the first communications device 512a decides to upgrade the first IMS session. For example, the first communications device 512a decides to add on VR to the IMS session, which requires a much larger bandwidth than voice.

### Action 714

The first communications device 512a issues a Re-INVITE message with a new Session Description Protocol (SDP) information reflecting the virtual reality session. This is forwarded all the way to first multimedia application server 523a.

### Action 715

The first multimedia application server 523a realizes that the first network slice identifier S-NSSAI_1a used by the first communications device 512a for establishing the PDU session for IMS is not applicable for this upgraded IMS session and a that a new second network slice identifier S-NSSAI_2a is required for VR. The first multimedia application server 523a may note that in the stored session state so that it may request the first communications device 512a (in the SIP response to be sent back to the first communications device 512a) to initiate a new PDU session for the upgraded IMS session.

In addition, the first multimedia application server 523a may inform the second communications device 512b at the terminating side that a new network slice is required at the originating side for the upgraded session, by inserting information in a SIP RE-INVITE information to that effect so that the second communications device 512b knows about this. Note that this is optional and has no impact on the second communications device 512b decision to whether or not the second communications device 512b should change network slices in the second communications network 500b to upgrade the IMS session.

### Action 716a

The Re-INVITE information is sent from first multimedia application server 523a to the second application network 520b.

### Action 716b

The Re-INVITE information is forwarded, e.g., via the second application node 521b, to the second multimedia application server 523b.

### Action 717

The second multimedia application server 523b may require that the second communications device 512b initiates a new PDU session for this upgraded IMS session. If the second multimedia application server 523b requires that the second communications device 512b initiates the new PDU session, it inserts to the second communications device 512b in the INVITE message information to that effect.

For example, the second multimedia application server 523b may include an indication that a second data session on the second network slice NS2a, NS2b identified by the second identifier S-NSSAI_2a, S-NSSAI_2b is required for the upgrade to handle the second media type to take place.

The indication may comprise a list of possible new network slice identifiers, which are configured in the second multimedia application server 523b, to be used by the second communications device 512b. The second communications device 512b should select a network slice identifier that it has in its access network subscription profile.

### Action 718

The second multimedia application server 523b forwards the modified SIP INVITE message to the second communications device 512b.

### Action 719

The second communications device 512b decides to accept the creation of a new second PDU session for IMS.

### Action 720

The second communications device 512b may accept the upgrade, or in other words the use of the second PDU session on the second network slice, by returning the SIP 200 OK message to the second application network 520b indicating that it will create the second PDU session for the new IMS session, such as a VR session.

### Actions 721a and 721b

The second multimedia application server 523b forwards the SIP 200 OK message from the second application network 520b to the first multimedia application server 523a. which may forward the message to the first communications network 500a, such as the originating side.

### Action 722

The first multimedia application server 523a forwards the message to the first communications network 500a, such as the originating side. The SIP 200 OK message arrives at the first multimedia application server 523a which may insert in the request to the first communications device 512a necessary information for the first communications device 512a to use a new PDU session for that new IMS session into the SIP 200 OK message. For example, the first multimedia application server 523a may include a list of possible new network slice identifiers, which are configured in first multimedia application server 523a, to be used by the first communications device 512a. The first communications device 512a should select a network slice identifier out of the received new network slice identifiers, which are configured in first multimedia application server 523a, such that it also matches with the network slice identifiers that it has in its access network subscription profile.

After receiving the SIP 200 OK message the first communications device 512a knows that a second PDU session is required at the originating end.

Now both the first communications device 512a and the second communications device 512b are aware that the new PDU session is required. Hence, they will tear down the ongoing IMS session, establish a new PDU IMS session with the new network slice identifier. Then the first communications device 512a initiates a new VR session which results in a successful IMS session. The call flow will not be described here since it corresponds to the first call flow including actions 701-712.

### Variants of the Above Example

If both ends have to establish a new PDU session to have a new network slice identifier then they will both do so and register to the application network 520a, 520b, such as IMS register, over the new data session, such as a new PDU IMS session. The originating side then establishes a new IMS VR session to the terminating second communications device 512b as described above and shown in the above call flow.

There are other cases that may be addressed in addition to the example where both ends have to establish a new PDU session. Three such cases are discussed below.
1) If the second communications device 512b cannot create a new PDU IMS session it may reject the Re-INVITE message for an upgrade with an appropriate error code.
2) If the first communications device 512a is required to establish a new PDU session and cannot do so then there no VR session will be established.
3) If only one end has to establish a new PDU session and the other end is not required, then the end that does not require a new PDU session remains IMS registered after. The old IMS session will still be torn down. For example, if only the first communication device 512a have to establish a new PDU IMS session using a new network slice, then the first communication device 512a will IMS register and then call the second communications device 512b with a new SDP.

The second communications device 512b now receives the second IMS VR session over the already established PDU session for IMS.

### Additional Considerations

In this example the application node acquired the network slice identifier used for the PDU IMS session at IMS session setup. The network slice identifier may also be acquired during registration. This would remove action 706 and the equivalent action in the terminating network if applicable.

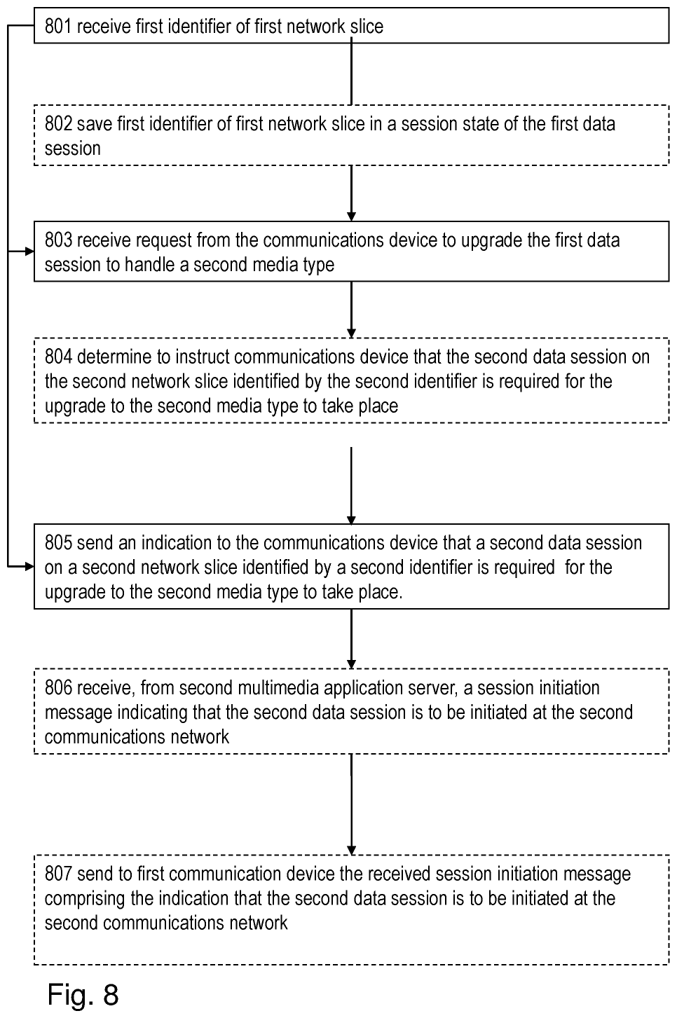

Exemplifying methods according to embodiments herein will now be described with reference to flowcharts of FIGS. 8-10 and with further reference to FIG. 5a and FIG. 5b. The flowcharts of FIGS. 8-10 complement the above-described signalling diagrams and describe exemplifying methods according to embodiments herein from a node perspective. Thus, FIGS. 8-10 describe methods performed by the first and second multimedia application servers 523a, 523b, the first and second communications devices 512a, 512b, and the first and second application nodes 521a, 521b and the first and second policy controlling node 506d_a, 506d_b.

The methods are for upgrading a first data session for a first media type to handle a second media type. The data session may also be referred to as a service session.

In some embodiments the application network 520a, 520b is an Internet Protocol-based multimedia system, such as IMS, providing the service to the communications devices 512a, 512b. Thus, the first and second data sessions may each be an IMS session.

The second media type may require a higher bandwidth or higher Quality of Service, QoS, than the first media type.

The second media type may, for example, be any one or more out of: Virtual Reality, VR, Augmented Reality, AR, and Mixed Reality, MR.

The method comprises one or more of the following actions, which actions may be taken in any suitable order.

FIG. 8 illustrates example methods performed by a multimedia application server, such as the first or second multimedia application server 523a, 523b.

### Action 801

The multimedia application server 523a, 523b receives the first identifier S-NSSAI_1a, S-NSSAI1b of the first network slice NS1a, NS1b of the communications network 500a, 500b from the application node 521a, 521b associated with the communications network 500a, 500b. The first data session is established by the communications device 512a, 512b through the first network slice NS1a, NS1b.

The first identifier S-NSSAI_1 a, S-NSSAI_1b of the first network slice NS1a, NS1b may be received during session setup of the first data session from the policy controlling node 506d_a, 506d_b in Npcf_PolicyAuthorisation_Subscribe Response. However, the first identifier S-NSSAI_1a, S-NSSAI_1 b of the first network slice NS1a, NS1b may also be received in other messages, for example during the registration procedure of the communications device 512a, 512b with the application network 520a, 520b.

Action 801 is related to action 709 of FIG. 7a.

### Action 802

In some embodiments the multimedia application server 523a, 523b saves the first identifier S-NSSAI_1a, S-NSSAI_1b of the first network slice in the session state associated with the first data session.

Action 801 is related to action 710 of FIG. 7a.

### Action 803

The multimedia application server 523a, 523b receives a request, from the first communications device 512a to upgrade the first data session to handle the second media type. The request comprises session description information corresponding to an upgraded data session handling the second media type.

The request may be a Re-invite SIP message, e.g., from the first communications device 512a. The session description information may be a Session Description Protocol information. For example, the Re-invite message may comprise SDP information corresponding to an upgraded IMS session. The following example embodiments will be described based on the assumption that the request is received from the first communications device 512a.

Action 803 is related to actions 714 and 716 of FIG. 7c.

### Action 804

The multimedia application server 523a, 523b may determine, based on the received first identifier S-NSSAI1a, S-NSSAI1b and the received session description information corresponding to the upgraded data session, to instruct the communications device 512a, 512b that the second data session on the second network slice NS2a, NS2b identified by the second identifier S-NSSAI_2a, S-NSSAI_2b is required for the upgrade to the second media type to take place.

For example, the first multimedia application server 523a may determine to instruct the first communications device 512a that the second data session on the second network slice NS2a of the first communications network 500a identified by the second identifier S-NSSAI_2a is required for the upgrade to the second media type to take place.

At the second communications network 500b, the second multimedia application server 523b may determine to instruct the second communications device 512b that the second data session on the second network slice NS2b of the second communications network 500b identified by the second identifier S-NSSAI_2b is required for the upgrade to the second media type to take place.

Since the multimedia application server 523a, 523b has received the received first identifier S-NSSAI1a, S-NSSAI1b and the received session description information corresponding to the upgraded data session in actions 801 and 803 above it is able to make this determination. The determination may for example be based on a match or mismatch between the received first identifier S-NSSAI1a, S-NSSAI1b and a required network slice identifier based on the received session description information corresponding to the upgraded data session.

Action 804 is related to actions 715 and 717 of FIG. 7c.

### Action 805

In response to the received request, and based on the first identifier S-NSSAI1a, S-NSSAI1b of the first network slice NS1a, NS1b and the session description information, the multimedia application server 523a, 523b sends an indication to the communications device 512a, 512b that a second data session on the second network slice NS2a, NS2b identified by the second identifier S-NSSAI_2a, S-NSSAI_2b is required for the upgrade to handle the second media type to take place.

The indication may be sent in a SIP message. For example, the second multimedia application server 523b may send the indication to the second communications device 512b in a SIP INVITE message. In another example, the first multimedia application server 523a may send the indication to the first communications device 512a in a SIP 200 OK response. This was detailed when describing FIGS. 7a-7d.

The indication may also be sent at SDP level.

In some embodiments the indication to the communications device 512a, 512b that the second data session on the second network slice NS2a, NS2b identified by the second identifier S-NSSAI_2a, S-NSSAI_2b is required for the upgrade to handle the second media type to take place is a list of second identifiers S-NSSAI_2a, S-NSSAI_2b, each associated with the respective second network slice NS2a, NS2b, which are configured in the multimedia application server 523a, 523b and support the second media type.

The list of second identifiers S-NSSAI_2a, S-NSSAI_2b sent to the communications device 512a, 512b may be determined by the multimedia application server 523a, 523b based on configured network slice identifiers in the multimedia application server 523a, 523b and based on which of the configured network slice identifiers that support the second media type. Thus, the multimedia application server 523a, 523b may select the second S-NSSAIs from its configured network slice identifiers based on which of the configured network slice identifiers that support the second media type.

Action 805 is related to actions 716 and 718 of FIG. 7c and actions 721 and 722 of FIG. 7d. In particular, action 805 is related to actions 718 and 722.

In some embodiments, wherein the first data session is established between the first communications device 512a and the second communications device 512b, and wherein the method is performed by the first multimedia application server 523a associated with the first communications network 500a providing the first data session to the first communications device 512a, the method further comprises the below actions.

### Action 806

Thus, in some embodiments the first multimedia application server 523a receives from the second multimedia application server 523b of the second application network 520b providing the first data session to the second communications device 512b, a session initiation message indicating that the second data session is to be initiated at the second communications network 500b.

The session initiation message may for example be a SIP 200 OK message.

Action 806 is related to action 721b of FIG. 7d.

### Action 807

When action 806 has been performed the first multimedia application server 523a may send the session initiation message indicating that the second data session is to be initiated at the second communications network 500b to the first communications device 512a, in response to the received indication that the second data session is to be initiated.

Action 807 is related to action 722 of FIG. 7d.

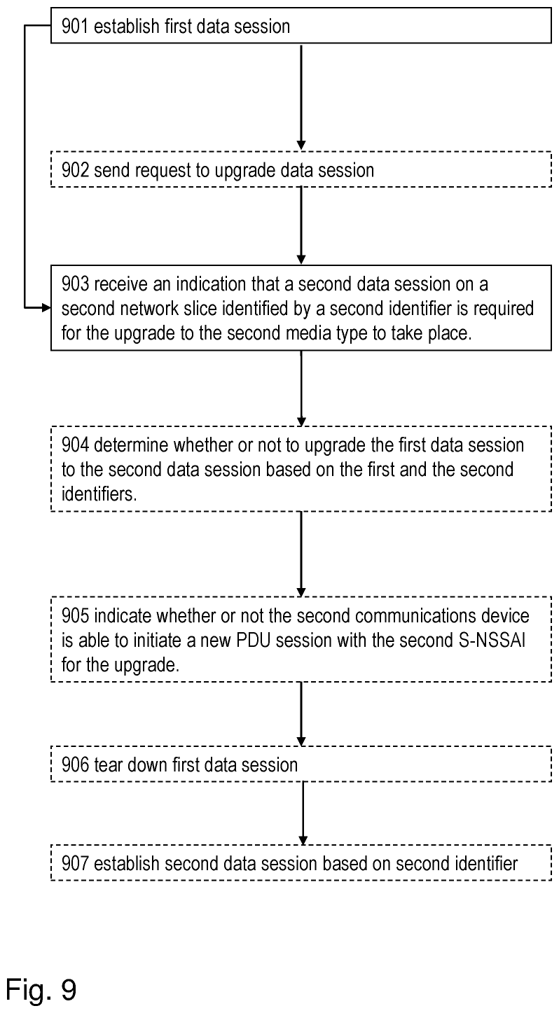

FIG. 9 illustrates example methods, performed by the communications device 512a, 512b, for upgrading the first data session of the first media type to handle the second media type.

The method comprises one or more or the following actions.

### Action 901

The communications device 512a, 512b establishes the first data session between the first communications device 512a and the second communications device 512b. The communications device 512a, 512b is one of the first or the second communications device 512a, 512b. The first data session is established by the communications device 512a, 512b on the first network slice NS1a, NS1b of the communications network 500a, 500b serving the communications device 512a, 512b wherein the first network slice NS1a, NS1b is identified by the first identifier S-NSSAI_1a, S-NSSAI_1 b.

Action 901 is related to actions 704-711 of FIG. 7a and actions 712a-d of FIG. 7b.

### Action 902

The first communications device 512a may send a request, to the application network 520a to upgrade the first data session to handle the second media type.

When the method is performed by the first communications device 512a then the first communications device 512a may send a request, to the first application network 520a, to upgrade the first data session to handle the second media type. The request from the first communications device 512a may be a SIP Invite message.

Action 902 is related to actions 705 of FIGS. 7a and 712a-712d of FIG. 7b.

### Action 903

The communications device 512a, 512b receives, from the multimedia application server 523a, 523b of the applications network 500a, 500b associated with the communications network 500a, 500b and controlling the first data session, the indication S-NSSAI_2a, S-NSSAI_2b that the second data session on the second network slice NS2a, NS2b identified by the second identifier S-NSSAI2a, S-NSSAI_2b is required for upgrading the first data session to handle the second media type.

As mentioned above in relation to action 805, in some embodiments the indication to the communications device 512a, 512b that the second data session is required for the upgrade to take place is a list of second identifiers S-NSSAI_2a, S-NSSAI_2b, each associated with the respective second network slice NS2a, NS2b, which are configured in the multimedia application server 523a, 523b and support the second media type.

The communications device 512a, 512b may receive the indication that the second data session on the second network slice NS2a, NS2b is required for the upgrade to handle the second media type to take place in response to the request to upgrade the first data session sent in action 902 above. For example, the first communications device 512a may receive the indication that the second data session on the second network slice NS2a is required in response to the request to upgrade the first data session which was described in action 722 above. In some embodiments the second communications device 512b receives the indication that the second data session on the second network slice NS2b is required as detailed in action 718 above. The request to upgrade the first data session may be sent by the first communications device 512a as described above in action 902.

The communications device 512a, 512b may further receive session description information corresponding to the upgraded data session handling the second media type, from the multimedia application server 523a, 523b. For example, the second communications device 512b may receive the session description information.

Action 903 is related to action 718 of FIG. 7c and action 722 of FIG. 7d.

### Action 904

In response to the received indication that the second data session on the second network slice NS2a, NS2b is required for the upgrade to the second media type to take place, the communications device 512a, 512b may determine whether or not to upgrade the first data session to the second data session based on the second identifier S-NSSAI_2a, S-NSSAI_2b and an access network subscription profile of the communications device 512a, 512b.

Action 904 is related to action 719 of FIG. 7d.

### Action 905

In further response to the received indication that the second data session on the second network slice NS2b is required for upgrading the first data session, the second communications device 512b may send a response to the multimedia application server 523a, 523b, such as the second multimedia application server 523b.

The response indicates whether or not the second communications device 512b is able to initiate the second data session with the second identifier S-NSSAI_2b for upgrading the first data session to handle the second media type. The response is based on the received second identifier S-NSSAI_2b and an access network subscription profile of the second communications device 512b. A positive response may imply acceptance by the second communications device 512b.

The response may be a SIP message, such as a SIP 200 OK message. The second application network 520b may forward the response to the first application network 520a and the first communications device 512a.

The response may indicate an acceptance or a rejection of the upgrade, for example, one of the following:
a) an indication that the second communications device 512b will initiate the second data session on the second network slice NS2b; and
b) a rejection of the upgrade, such as an error code.

Action 905 is related to action 720 of FIG. 7d.

### Action 906

In order to upgrade the first data session, the communications device 512a, 512b may tear down the first data session.

### Action 907

Then the communications device 512a, 512b may establish the second data session based on the second identifier S-NSSAI_2a, S-NSSAI_2b.

The establishment of the second data session may be seen as an acceptance from the first communications device 512a of the received request for upgrading the first data session, that is, of the received indication of the required upgrade.

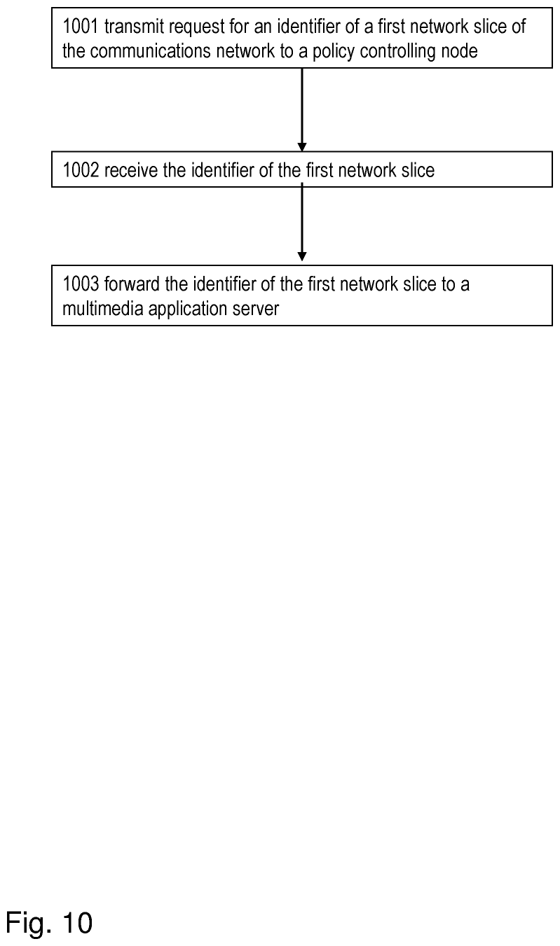

FIG. 10 illustrates example methods, performed by the application node 521 a, 521b, for assisting in upgrading the first data session for the first media type to handle the second media type.

The method comprises one or more or the following actions.

### Action 1001

The application node 521 a, 521b transmits, to the policy controlling node 506d_a, 506d_b of the communications network 500a, 500b, a request for the first identifier S-NSSAI1 of the first network slice NS1a, NS1b of the communications network 500a. As mentioned above, the first network slice NS1a, NS1b is used to establish the first data session by the communications device 512a, 512b.

In some embodiments transmitting the request for the first identifier S-NSSAI1 is performed in response to an initiation of the first data session. For example, the initiation of the first data session may be performed by the first communications device 512a by sending a SIP INVITE message to the second communications device 512b via the first application node 521a, such as a first P-CSCF.

Action 1001 is related to action 706 of FIG. 7a.

### Action 1002

The application node 521 a, 521b then receives, from the policy controlling node 506d_a, 506d_b, the first identifier S-NSSAI1 of the first network slice NS1a, NS1b in response to the transmitted request for the first identifier.

Action 1002 is related to action 707 of FIG. 7a.

### Action 1003

The application node 521 a, 521b then forwards the first identifier S-NSSAI_1 a, S-NSSAI_1b of the first network slice NS1a, NS1b to the multimedia application server 523a, 523b, such that the multimedia application server 523a, 523b is able to determine whether or not the first data session is able to handle the second media type based on the first identifier S-NSSAI_1a, S-NSSAI_1b of the first network slice NS1a, NS1b and session description information corresponding to an upgraded data session handling the second media type.

Action 1003 is related to action 709 of FIG. 7a.

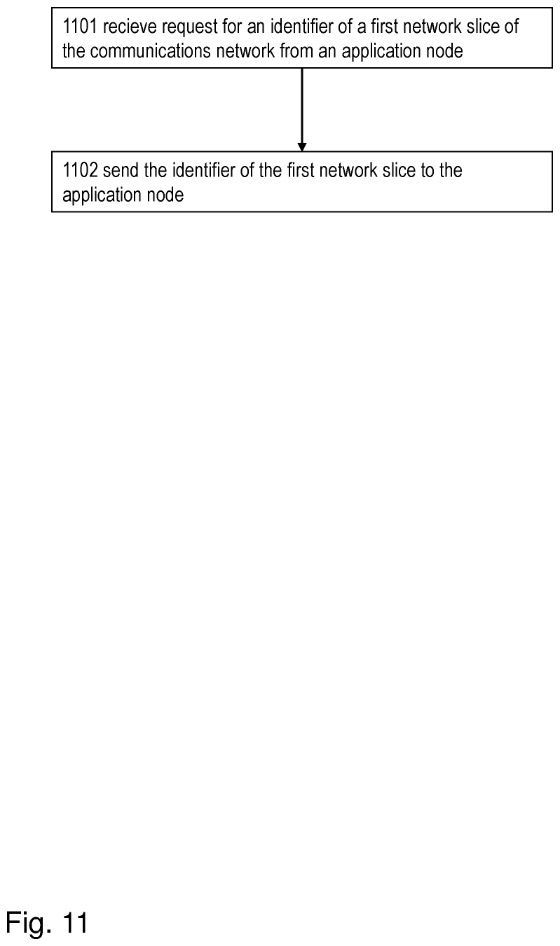

FIG. 11 illustrates example methods, performed by the policy controlling node 506d_a, 506d_b of the communications network 500a, 500b. The method comprises one or more or the following actions.

### Action 1101

The policy controlling node 506d_a, 506d_b receives, from the application node 521a, 521b associated with the communications network 500a, 500b, the request for the first identifier S-NSSAI_1a, S-NSSAI_1 b of the first network slice NS1a, NS1b of the communications network 500a. As mentioned above, the first network slice NS1a, NS1b is used for the first data session between the first communications device 512a and the second communications device 512b.

Action 1101 is related to action 706 of FIG. 7a.

### Action 1102

The policy controlling node 506d_a, 506d_b sends the first identifier S-NSSAI_1 a, S-NSSAI_1b of the first network slice NS1a, NS1b to the application node 521a, 521b in response to the received request.

Action 1102 is related to action 707 of FIG. 7a.

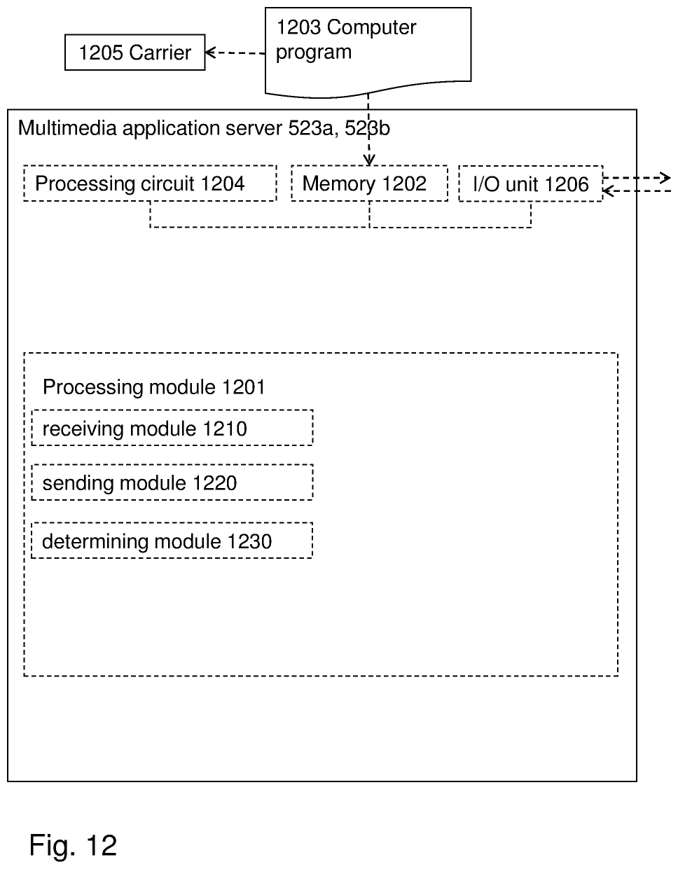

FIG. 12 illustrates a schematic block diagram of embodiments of the multimedia application server 523a, 523b.

The multimedia application server 523a, 523b may comprise a processing module 1201 for performing the above method actions. The processing module 1201 may comprise a receiving module 1210 to, e.g. receive different messages.

Thus the multimedia application server 523a, 523b is configured to, e.g. by means of the receiving module 1210, receive the first identifier S-NSSAI_1a, S-NSSAI1b of the first network slice NS1a, NS1b of the communications network 500a, 500b from the application node 521a, 521b. The first data session is established by the communications device 512a, 512b through the first network slice NS1a, NS1b.

The multimedia application server 523a, 523b is configured to, e.g. by means of the receiving module 1210, receive the request, from the first communications device 512a to upgrade the first data session to handle the second media type. The request comprises session description information corresponding to an upgraded data session handling the second media type.

The processing module 1201 may comprise a sending module 1220 to, e.g. send different messages. Thus the multimedia application server 523a, 523b is configured to, e.g. by means of the sending module 1220, send the indication to the communications device 512a, 512b that the second data session on the second network slice NS2a, NS2b identified by the second identifier S-NSSAI_2a, S-NSSAI_2b is required for the upgrade to handle the second media type to take place. The multimedia application server 523a, 523b is configured to, e.g. by means of the sending module 1220, send the indication in response to the received request, and based on the first identifier S-NSSAI1a, S-NSSAI1b of the first network slice NS1a, NS1b and the session description information.

The processing module 1201 may comprise a determining module 1230. Thus the multimedia application server 523a, 523b may be configured to, e.g. by means of the determining module 1230, determine based on the received first identifier S-NSSAI1a, S-NSSAI1b and the received session description information corresponding to the upgraded data session, to instruct the communications device 512a, 512b that the second data session on the second network slice NS2a, NS2b identified by the second identifier S-NSSAI_2 a, S-NSSAI_2b is required for the upgrade to the second media type to take place.

In some embodiments the first data session is adapted to be established between the first communications device 512a and the second communications device 512b, and the multimedia application server 523a, 523b is the first multimedia application server 523a associated with the first communications network 500a adapted to provide the first data session to the first communications device 512a. Then the first multimedia application server 523a may be further configured to, e.g. by means of the receiving module 1210, receive from the second multimedia application server 523b associated with the second communications network 500b, the session initiation message indicating that the second data session is to be initiated at the second communications network 500b.

Then the multimedia application server 523a, 523b may be further configured to, e.g. by means of the sending module 1220, send the indication to the first communications device 512a that the second data session on the second network slice NS2a, NS2b identified by the second identifier S-NSSAI_2a, S-NSSAI_2b is required for the upgrade to the second media type to take place, in response to the received indication that the second data session is to be initiated.

In some embodiments the multimedia application server 523a, 523b is further configured to, e.g. by means of a memory module 1202, save the first identifier S-NSSAI_1 a, S-NSSAI_1b of the first network slice in the session state associated with the first data session.

In some embodiments the multimedia application server 523a, 523b is further configured to, e.g. by means of the receiving module 1210, receive the first identifier S-NSSAI_1 a, S-NSSAI_1b of the first network slice NS1a, NS1b during session setup of the first data session from the policy controlling node 506d in an Npcf_PolicyAuthorisation_Subscribe Response or during the registration procedure of the communications device 512a, 512b with the application network 520a, 520b.

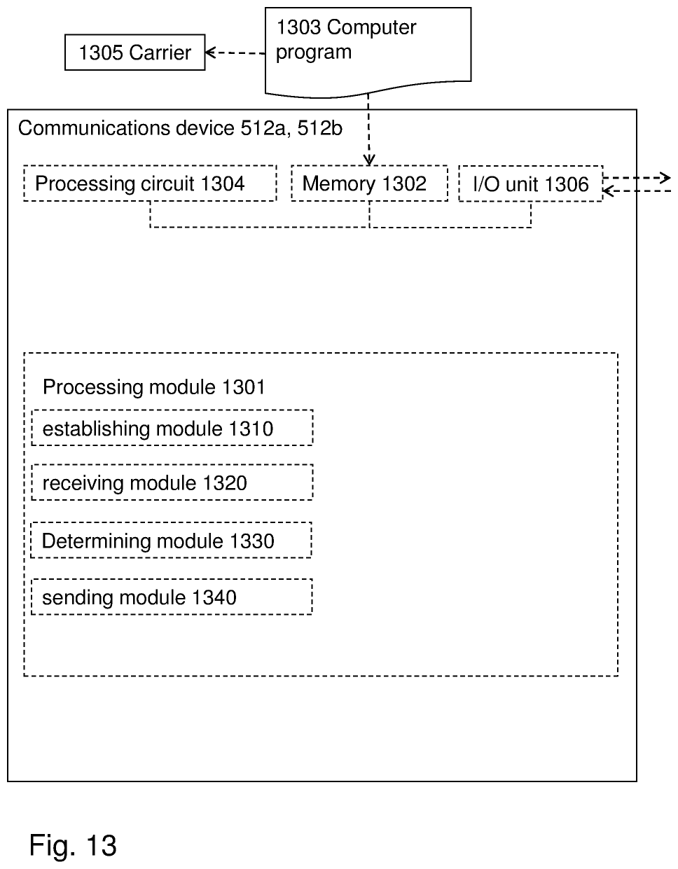

FIG. 13 illustrates a schematic block diagram of embodiments of the communications device 512a, 512b.

The communications device 512a, 512b may comprise a processing module 1301 for performing the above method actions. The processing module 1301 may comprise an establishing module 1310 to, e.g. establish the data session, such as an IMS session, or in other words a PDU session for IMS.

Thus, the communications device 512a, 512b is configured to, e.g. by means of the establishing module 1310, establish the first data session between the first communications device 512a and the second communications device 512b. The communications device 512a, 512b is one of the first or the second communications device 512a, 512b. The first data session is adapted to be established by the communications device 512a, 512b on the first network slice NS1a, NS1b of the communications network 500a, 500b adapted to serve the communications device 512a. The first network slice NS1a, NS1b is adapted to be identified by the first identifier S-NSSAI_1 a, S-NSSAI_1b.

The processing module 1301 may comprise a receiving module 1320 to, e.g. receive different messages.

Thus, the communications device 512a, 512b is configured to, e.g. by means of the receiving module 1320, receive from the multimedia application server 523a, 523b associated with the communications network 500a, 500b and adapted to control the first data session, an indication S-NSSAI_2a, S-NSSAI_2b that the second data session on the second network slice NS2a, NS2b identified by the second identifier S-NSSAI2a, S-NSSAI_2 b is required for upgrading the first data session to handle the second media type.

The processing module 1301 may comprise a determining module 1330.

Then the communications device 512a, 512b may be further configured to, e.g. by means of the determining module 1330, determine whether or not to upgrade the first data session to the second data session based on the second identifier S-NSSAI_2a, S-NSSAI_2 b and an access network subscription profile of the communications device 512a, 512b. The determination may be performed in response to the received indication that the second data session on the second network slice NS2a, NS2b is required for the upgrade to the second media type to take place.

The processing module 1301 may comprise a sending module 1340. In some embodiments the communications device 512a, 512b is further configured to, e.g. by means of the sending module 1340, send, to the multimedia application server 523a, 523b, a response to the received indication that the second data session on the second network slice NS2a, NS2b is required for upgrading the first data session. The response indicates whether or not the second communications device 512b is able to initiate the second data session with the second identifier S-NSSAI2a, S-NSSAI_2b for upgrading the first data session to handle the second media type. The response is based on the received second identifier S-NSSAI_2b and an access network subscription profile of the second communications device 512b.

In some embodiments the communications device 512a, 512b is adapted to be the first communications device 512a. Then the communications device 512a, 512b may further be configured to, e.g. by means of the sending module 1340, send a request, to the first application network 520a, to upgrade the first data session to handle the second media type.

The communications device 512a, 512b may further be configured to, e.g. by means of the receiving module 1320, receive the indication that the second data session on the second network slice NS2a is required for the upgrade to handle the second media type to take place in response to the request to upgrade the first data session.

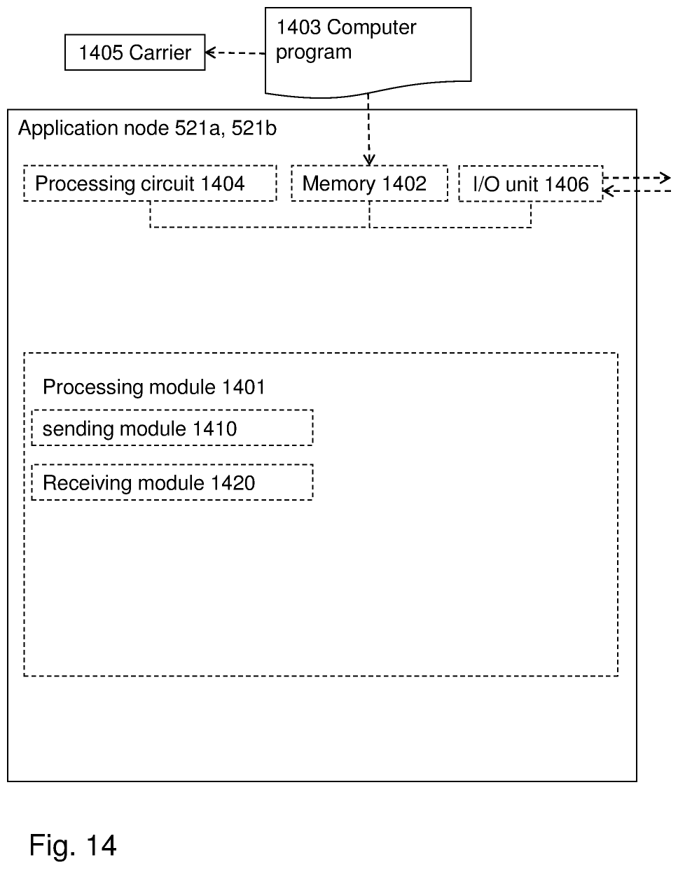

FIG. 14 illustrates a schematic block diagram of embodiments of the application node 521a, 521b, for assisting in upgrading the first data session.

The application node 521 a, 521b may comprise a processing module 1401 for performing the above method actions. The processing module 1401 may comprise a sending module 1410 to, e.g. send messages.

Thus, the application node 521 a, 521b is configured to, e.g. by means of the receiving module 1310, send to the policy controlling node 506d_a, 506d_b of the communications network 500a, 500b, the request for the first identifier S-NSSAI1 of the first network slice NS1a, NS1b of the communications network 500a. The first network slice NS1a, NS1b is used to establish the first data session by the communications device 512a, 512b.

The processing module 1401 may further comprise a receiving module 1420.

Thus, the application node 521 a, 521b is configured to, e.g. by means of the receiving module 1420, receive, from the policy controlling node 506d_a, 506d_b, the first identifier S-NSSAI1 of the first network slice NS1a, NS1b in response to the transmitted request for the first identifier.

The application node 521 a, 521b is configured to, e.g. by means of the sending module 1420, forward the first identifier S-NSSAI_1a, S-NSSAI_1b of the first network slice NS1a, NS1b to the multimedia application server 523a, 523b such that the multimedia application server 523a, 523b is able to determine whether or not the first data session is able to handle the second media type based on the first identifier S-NSSAI_1 a, S-NSSAI_1b of the first network slice NS1a, NS1b and session description information corresponding to an upgraded data session handling the second media type.

In some embodiments the application node 521 a, 521b is configured to transmit the request in response to an initiation of the first data session.

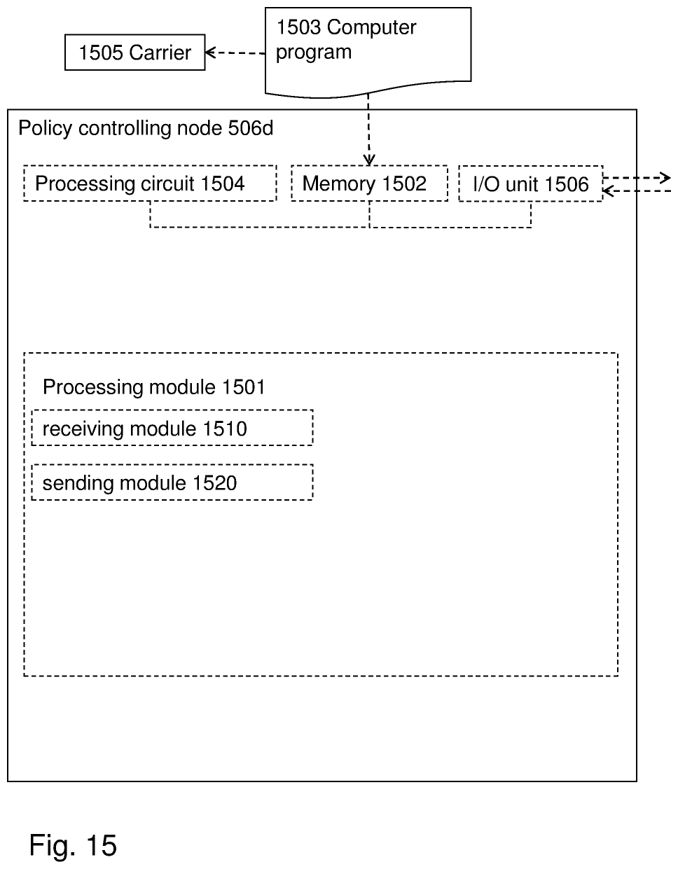

FIG. 15 illustrates a schematic block diagram of embodiments of the policy controlling node 506d_a, 506d_b of the communications network 500a, 500b.

The policy controlling node 506d_a, 506d_b may comprise a receiving module 1510 and a sending module 1520.

The policy controlling node 506d_a, 506d_b is configured to, e.g. by means of the receiving module 1510, receive from an application node 521a, 521b associated with the communications network 500a, 500b, the request for the first identifier S-NSSAI_1a, S-NSSAI_1b of the first network slice NS1a, NS1b of the communications network 500a. The first network slice NS1a, NS1b is adapted to be used for the first data session between the first communications device 512a and the second communications device 512b.

The policy controlling node 506d_a, 506d_b is configured to, e.g. by means of the sending module 1520, send the first identifier S-NSSAI_1 a, S-NSSAI_1 b of the first network slice NS1a, NS1b to the application node 521a, 521b in response to the received request.

The multimedia application server 523a, 523b, the communications device 512a, 512b, the application node 521a, 521b, and the policy controlling node 506d_a, 506d_b may comprise a respective input and output unit, 1206, 1306, 1406 and 1506 configured to communicate with each other. The input and output unit may comprise a receiver (not shown) and a transmitter (not shown).

The embodiments herein may be implemented through a respective processor or one or more processors, such as the respective processing circuit 1204, 1304, 1404 and 1504 in the multimedia application server 523a, 523b, the communications device 512a, 512b, the application node 521 a, 521b, and the policy controlling node 506d_a, 506d_b depicted in FIGS. 12-15, together with computer program code for performing the functions and actions of the embodiments herein. The program code mentioned above may also be provided as a computer program product, for instance in the form of a data carrier carrying computer program code for performing the embodiments herein when being loaded into the respective the multimedia application server 523a, 523b, the communications device 512a, 512b, the application node 521a, 521b, and the policy controlling node 506d_a, 506d_b. One such carrier may be in the form of a CD ROM disc. It is however feasible with other data carriers such as a memory stick. The computer program code may furthermore be provided as pure program code on a server or a cloud and downloaded to the respective multimedia application server 523a, 523b, communications device 512a, 512b, application node 521a, 521b, and policy controlling node 506d_a, 506d_b.

The multimedia application server 523a, 523b, the communications device 512a, 512b, the application node 521a, 521b, and the policy controlling node 506d_a, 506d_b may further comprise a respective memory 1202, 1302, 1402 and 1502 comprising one or more memory units. The memory comprises instructions executable by the processor in the multimedia application server 523a, 523b, the communications device 512a, 512b, the application node 521a, 521b, and the policy controlling node 506d_a, 506d_b.

Each respective memory 1202, 1302, 1402 and 1502 is arranged to be used to store e.g. information, data, configurations, and applications to perform the methods herein when being executed in the respective multimedia application server 523a, 523b, communications device 512a, 512b, application node 521a, 521b, and policy controlling node 506d_a, 506d_b.

In some embodiments, a respective computer program 1203, 1303, 1403 and 1503 comprises instructions, which when executed by the at least one processor, cause the at least one processor of the respective multimedia application server 523a, 523b, communications device 512a, 512b, application node 521a, 521b, and policy controlling node 506d_a, 506d_b to perform the actions above.

In some embodiments, a respective carrier 1205, 1305, 1405 and 1505 comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units in the units described above may refer to a combination of analog and digital circuits, and/or one or more processors configured with software and/or firmware, e.g. stored in the respective multimedia application server 523a, 523b, communications device 512a, 512b, application node 521a, 521b, and policy controlling node 506d_a, 506d_b, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

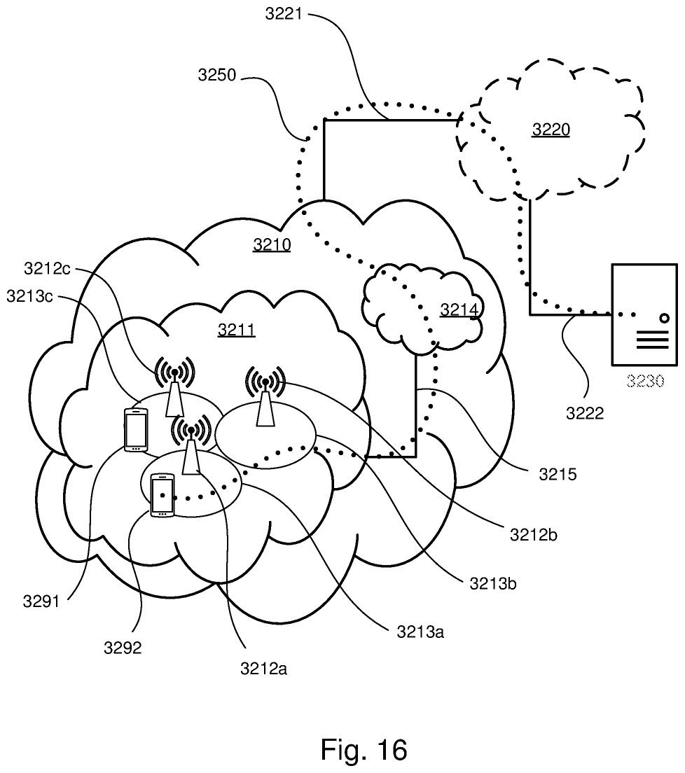

With reference to FIG. 16, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the source and target access node 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider.

The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 16 as a whole enables connectivity between one of the connected UEs 3291, 3292 such as e.g. the UE 121, and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

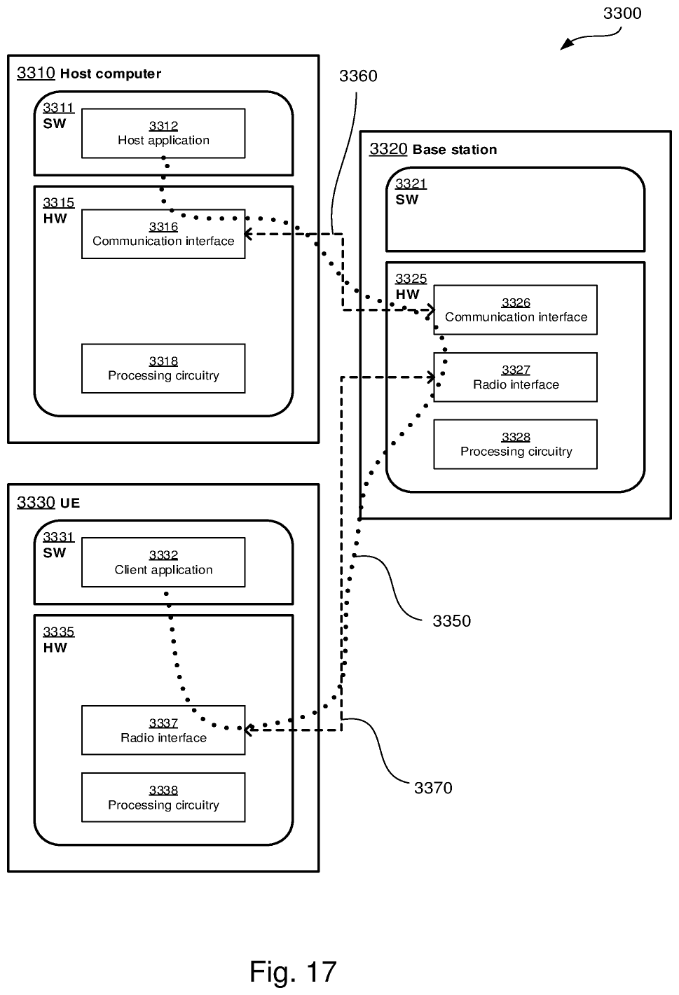

Example implementations, in accordance with an embodiment, of the UE, base station and host computer discussed in the preceding paragraphs will now be described with reference to FIG. 17. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 17) served by the base station 3320. The communication interface 3326 may be configured to facilitate a connection 3360 to the host computer 3310. The connection 3360 may be direct or it may pass through a core network (not shown in FIG. 17) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 17 may be identical to the host computer 3230, one of the base stations 3212a, 3212b, 3212c and one of the UEs 3291, 3292 of FIG. 16, respectively. This is to say, the inner workings of these entities may be as shown in FIG. 17 and independently, the surrounding network topology may be that of FIG. 16.

In FIG. 17, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve.

There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

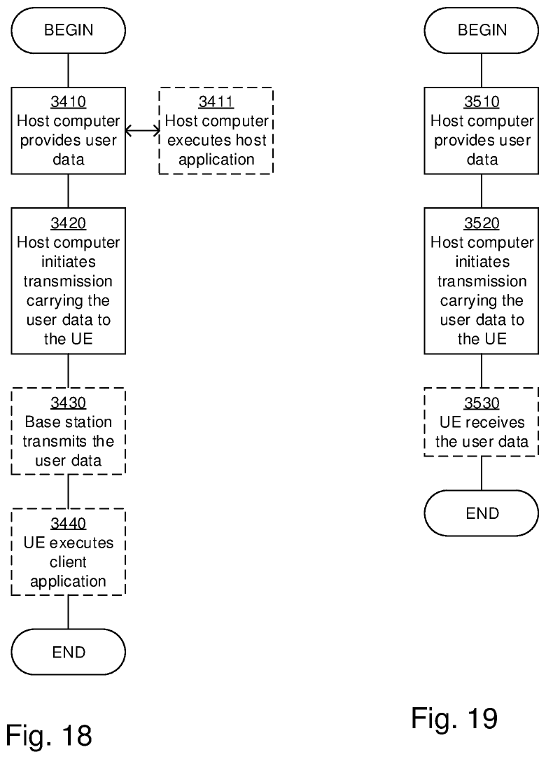

FIG. 18 is a flowchart illustrating a method implemented in a communication system, in accordance with one embodiment. The communication system includes a host computer, a base station such as a AP STA, and a UE such as a Non-AP STA which may be those described with reference to FIG. 16 and FIG. 17. For simplicity of the present disclosure, only drawing references to FIG. 18 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 19 is a flowchart illustrating a method implemented in a communication system, in accordance with one embodiment. The communication system includes a host computer, a base station such as a AP STA, and a UE such as a Non-AP STA which may be those described with reference to FIG. 16 and FIG. 17. For simplicity of the present disclosure, only drawing references to FIG. 19 will be included in this section. In a first action 3510 of the method, the host computer provides user data.

In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3512, the UE receives the user data carried in the transmission.

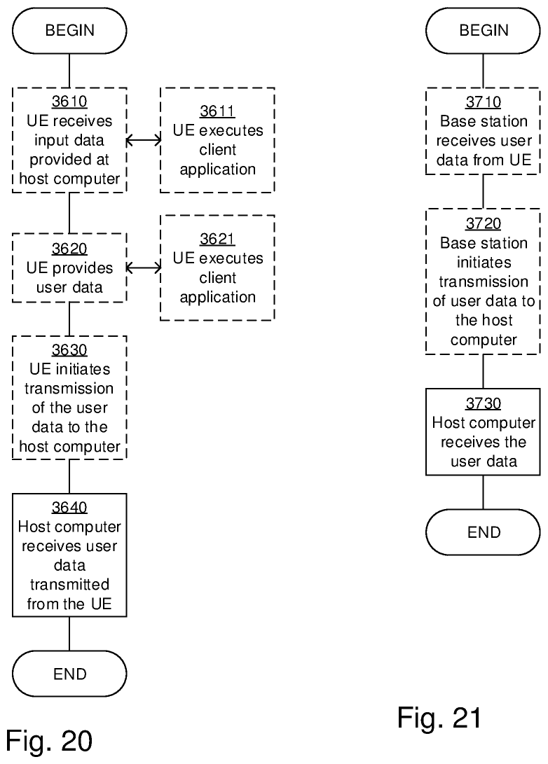

FIG. 20 is a flowchart illustrating a method implemented in a communication system, in accordance with one embodiment. The communication system includes a host computer, a base station such as a AP STA, and a UE such as a Non-AP STA which may be those described with reference to FIG. 16 and FIG. 17. For simplicity of the present disclosure, only drawing references to FIG. 20 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 21 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. (canceled)

2. A method, performed by a multimedia application server, for upgrading a first data session for a first media type to handle a second media type, the method comprising:
receiving, from an application node associated with a communications network, a first identifier (S-NSSAI_1a, S-NSSAI1b) of a first network slice (NS2a, NS2b) of the communications network, wherein the first data session is established by a communications device through the first network slice;
receiving a request, from the first communications device to upgrade the first data session to handle the second media type, wherein the request comprises session description information corresponding to an upgraded data session handling the second media type; and
in response to the received request, and based on the first identifier (S-NSSAI1a, S-NSSAI1b) of the first network slice (NS2a, NS2b) and the session description information, sending an indication to the communications device that a second data session on a second network slice (NS2a, NS2b) identified by a second identifier (S-NSSAI_2a, S-NSSAI_2b) is required for the upgrade to handle the second media type to take place.

3. The method according to claim 2, wherein the second media type requires a higher bandwidth or higher Quality of Service, QoS, than the first media type.

4. The method according to claim 2, wherein the second media type is any one or more out of: Virtual Reality, VR, Augmented Reality, AR, and Mixed Reality, MR.

5. The method according to claim 2, wherein the first and second data sessions each is an IMS session.

6. The method according to claim 2, wherein the indication to the communications device that the second data session on the second network slice identified by the second identifier (S-NSSAI_2a, S-NSSAI_2b) is required for the upgrade to handle the second media type to take place is a list of second identifiers (S-NSSAI_2a, S-NSSAI_2b), each associated with a respective second network slice, which are configured in the multimedia application server and support the second media type.

7. The method according to claim 2, further comprising:
determining, based on the received first identifier (S-NSSAI1a, S-NSSAI1b) and the received session description information corresponding to the upgraded data session, to instruct the communications device that the second data session on the second network slice (NS2a, NS2b) identified by the second identifier (S-NSSAI_2a, S-NSSAI_2b) is required for the upgrade to the second media type to take place.

8. The method according to claim 2, wherein the first data session is established between a first communications device and a second communications device, and wherein the method is performed by a first multimedia application server associated with a first communications network providing the first data session to the first communications device, the method further comprising:
receiving, from a second multimedia application server controlling the first data session, a session initiation message indicating that the second data session is to be initiated at the second communications network; and
sending the indication to the first communications device that the second data session on the second network slice (NS2a, NS2b) identified by the second identifier (S-NSSAI_2a, S-NSSAI_2b) is required for the upgrade to the second media type to take place, in response to the received indication that the second data session is to be initiated.

9. The method according to claim 2, further comprising: saving the first identifier (S-NSSAI_1a, S-NSSAI_1b) of the first network slice in a session state associated with the first data session.

10. The method according to claim 2, wherein the first identifier (S-NSSAI_1a, S-NSSAI_1b) of the first network slice (NSA1a, NS1b) is received during session setup of the first data session from a policy controlling node in Npcf_PolicyAuthorisation_Subscribe Response or during a registration procedure of the communications device with the application network.

11. A method, performed by a communications device, for upgrading a first data session of a first media type to handle a second media type, the method comprising:
establishing a first data session between a first communications device and a second communications device, wherein the communications device is one of the first or the second communications device and wherein the first data session is established by the communications device on a first network slice (NS2a, NS2b) of a communications network serving the communications device, wherein the first network slice (NS1a, NS1b) is identified by a first identifier (S-NSSAI_1a, S-NSSAI_1b); and
receiving, from a multimedia application server associated with the communications network and controlling the first data session, an indication (S-NSSAI_2a, S-NSSAI_2b) that a second data session on a second network slice identified by a second identifier (S-NSSAI2a, S-NSSAI_1b) is required for upgrading the first data session to handle the second media type.

12. The method according to claim 11, further comprising:
in response to the received indication that the second data session on the second network slice (NS2a, NS2b) is required for the upgrade to the second media type to take place, determining whether or not to upgrade the first data session to the second data session based on the second identifier (S-NSSAI_2a, S-NSSAI_2b) and an access network subscription profile of the communications device.

13. The method according to claim 11, wherein the method further comprises: in response to the received indication, sending, to the multimedia application server a response to the received indication that the second data session on the second network slice (NS2a, NS2b) is required for upgrading the first data session, wherein the response indicates whether or not the second communications device is able to initiate the second data session with the second identifier (S-NSSAI2a, S-NSSAI_2b) for upgrading the first data session to handle the second media type, and wherein the response is based on the received second identifier (S-NSSAI_2b) and an access network subscription profile of the second communications device.

14. The method according to claim 11, performed by the first communications device, the method further comprising:
sending a request, to the first application network, to upgrade the first data session to handle the second media type; and
wherein the first communications device receives the indication that the second data session on the second network slice (NS2a) is required for the upgrade to handle the second media type to take place in response to the request to upgrade the first data session.

15. A method, performed by an application node associated with a communications network, for assisting in upgrading a first data session for a first media type to handle a second media type, the method comprising:
transmitting, to a policy controlling node of a communications network, a request for a first identifier of a first network slice (NS2a, NS2b) of the communications network, which first network slice (NS2a, NS2b) is used to establish the first data session by a communications device;
receiving, from the policy controlling node, the first identifier (S-NSSAI1) of the first network slice (NS2a, NS2b) in response to the transmitted request for the first identifier; and
forwarding the first identifier (S-NSSAI_1a, S-NSSAI_2b) of the first network slice (NS2a, NS2b) to a multimedia application server, such that the multimedia application server is able to determine whether or not the first data session is able to handle the second media type based on the first identifier (S-NSSAI_1a, S-NSSAI_2b) of the first network slice (NS2a, NS2b) and session description information corresponding to an upgraded data session handling the second media type.

16. The method according to claim 15, wherein transmitting the request for the first identifier is performed in response to an initiation of the first data session.

17-19. (canceled)

20. A multimedia application server associated with a communications network, for upgrading a first data session for a first media type to handle a second media type, wherein the multimedia application server is configured to:
receive from an application node associated with the communications network, a first identifier (S-NSSAI_1a, S-NSSAI1b) of a first network slice (NS2a, NS2b) of the communications network, wherein the first data session is established by a communications device through the first network slice;
receive a request, from the communications device to upgrade the first data session to handle a second media type, wherein the request comprises session description information corresponding to an upgraded data session handling the second media type; and
in response to the received request, and based on the first identifier (S-NSSAI_1a, S-NSSAI2b) of the first network slice and the session description information, send an indication to the communications device that a second data session on a second network slice (NS2a, NS2b) identified by a second identifier (S-NSSAI_2a, S-NSSAI_2b) is required for the upgrade to handle the second media type to take place.

21. The multimedia application server according to claim 20, wherein the second media type requires a higher bandwidth or higher Quality of Service, QoS, than the first media type.

22. The multimedia application server according to claim 20, wherein the second media type is any one or more out of: Virtual Reality, VR, Augmented Reality, AR, and Mixed Reality, MR.

23-35. (canceled)
